(19) United States
(12) Patent Application Publication
(10) Pub. No.: US 2025/0307596 A1
(43) Pub. Date: Oct. 2, 2025

(54) GRAPH-BASED MODELS WITH COMPLEX NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT INC., Columbus, IN (US)

(21) Appl. No.: 18/621,879

(22) Filed: Mar. 29, 2024

(51) Int. Cl. G06N 3/04

(52) U.S. Cl. CPC G06N 3/04

(57) ABSTRACT

An overlay system is provided that includes a storage element and processing circuitry coupled thereto. The storage element stores an executable graph-based model having a plurality of nodes. The processing circuitry receives a stimulus indicative of creation of a complex node in the executable graph-based model. The processing circuitry identifies, from the plurality of nodes, a set of nodes associated with the creation of the complex node. The processing circuitry determines, for each of the set of nodes, a node-type that indicates a node behavior of the corresponding node. The processing circuitry further determines, based on the node-type of each of the set of nodes, a complex node behavior that is indicative of a set of operations to be performed for the creation of the complex node. The processing circuitry executes the set of operations on the set of nodes to create the complex node.

### FIELD OF THE DISCLOSURE

Various embodiments of the present disclosure relate generally to graph-based models. More specifically, various embodiments of the present disclosure relate to executable graph-based models with complex nodes.

### BACKGROUND

Traditionally, graph-based models are used to implement systems associated with various domains such as neural networks, database models, or the like. The graph-based models include vertices and edges, where vertices represent real-world entities and edges represent the association between the entities. Further, a system associated with a domain may have one or more frequently executed operations. Such frequently executed operations may be associated with a set of nodes of a graph-based model associated with the system. In other words, a functionality or behavior associated with the set of nodes may be frequently required. Hence, the set of nodes is required to be retrieved and accessed every time the operation is to be executed. Such frequent retrieval and access of the set of nodes renders the graph-based model complicated, time-intensive, cost-intensive, and inconvenient to use. Therefore, use of the graph-based models for the implementation of such systems is undesirable.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating creation and maintenance of complex nodes in executable graph-based models are provided substantially as shown in, and described in connection with, at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, in accordance with an embodiment of the present disclosure;

FIG. 2 is a block diagram that illustrates a system environment of an overlay system for execution, management, and configuration of the executable graph-based model, in accordance with an embodiment of the present disclosure;

FIG. 3A is a block diagram that illustrates a generic structure of a node within the executable graph-based model, in accordance with an embodiment of the present disclosure;

FIG. 3B is a block diagram that illustrates a generic structure of a run-time node within the executable graph-based model, in accordance with an embodiment of the present disclosure;

FIG. 4 is a block diagram that illustrates an executable node within the executable graph-based model, in accordance with an embodiment of the present disclosure;

FIG. 5 is a block diagram that illustrates a composition of the executable node that enables persistent storage of data and processing logic associated therewith, in accordance with an embodiment of the present disclosure;

FIG. 6 illustrates a block diagram that depicts features of a complex node, in accordance with an embodiment of the present disclosure;

FIG. 7A is a block diagram that illustrates a structure of the complex node, in accordance with an embodiment of the present disclosure;

FIG. 7B is a block diagram that illustrates a structure of a run-time complex node, in accordance with an embodiment of the present disclosure;

FIG. 8 is a schematic diagram that illustrates a mechanism for storage and loading of a complex node, in accordance with an embodiment of the present disclosure;

FIGS. 9A and 9B are schematic diagrams that, collectively, illustrate a mechanism for storage and loading of the run-time complex node, in accordance with an embodiment of the present disclosure;

FIGS. 10A-10G are schematic diagrams that illustrate creation of complex nodes based on a join complex node behavior, in accordance with an embodiment of the present disclosure;

FIGS. 11A-11C are schematic diagrams that illustrate creation of the complex nodes based on a merge complex node behavior, in accordance with an embodiment of the present disclosure;

FIGS. 12A-12C are schematic diagrams that illustrate creation of the complex nodes based on the merge complex node behavior, in accordance with another embodiment of the present disclosure;

FIGS. 13A-13C are schematic diagrams that illustrate an example implementation of the overlay system, in accordance with an embodiment of the present disclosure;

FIG. 14 shows an example computing system for carrying out methods of the present disclosure, in accordance with an embodiment of the present disclosure; and

FIGS. 15A-15C, collectively, illustrate a flowchart of a method for creation of the complex node, in accordance with an embodiment of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

In recent times, various technologies have been implemented by way of graph-based models, where each unit associated with a technology is realized as a node of a corresponding graph-based model. Such use of the graph-based model enables complete control over even the smallest unit of the technology. Data and processing logic associated with the technology are stored separately such that the data is retrieved and the processing logic is executed on the retrieved data as and when required. In other words, operations associated with the technology are performed by executing corresponding processing logic on relevant nodes of the graph-based model. One or more operations associated with the technology may be frequently executed. Such operations may be executed by way of a corresponding set of nodes. Therefore, frequent retrieval and access of the data and the processing logic are performed, where each retrieval and access results in execution of a corresponding transaction. Hence, the time complexity and cost complexity associated with such operations are significant. Moreover, in many instances, the same processing logic may be required to be executed on multiple nodes of the graph-based model, hence, the processing logic is retrieved and executed separately for each node.

The present disclosure is directed to the facilitation of the creation and maintenance of complex nodes in an executable graph-based model of an overlay system. The executable graph-based model is a customized hypergraph having hyper-edges and vertices that are realized by way of executable nodes. Each executable node is a base node that is extended by way of one or more overlays. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features (for example, creation and maintenance of complex nodes) in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein may be used to create and maintain complex nodes in the executable graph-based model. A complex node refers to a high-level node in the executable graph-based model. The complex node is a combination of a set of nodes of the executable graph-based model. The complex node exhibits features and capabilities of the set of nodes encompassed therein. In an instance, the set of nodes may be required for execution of an operation associated with the overlay system. In such an instance, only the complex node that includes the set of nodes is required to be retrieved and the processing logic is to be executed only on the complex node. A single transaction is executed for the retrieval of the complex node. Subsequently, the processing logic is executed on the retrieved complex node. Thus, the time required for loading and referring each of the set of nodes, and execution of the processing logic on each node of the set of nodes is significantly decreased. In another instance, the same processing logic may be required to be executed on the set of nodes. Therefore, the execution of the processing logic on the complex node significantly reduces duplication within the executable graph-based model and optimizes resource utilization within the overlay system. Additionally, in some instances, the execution of the processing logic may require the set of nodes, where one or more nodes of the set of nodes may be required in different instances during the execution. Therefore, such execution of the processing logic is complicated. Hence, the creation of the complex node to combine the set of nodes simplifies the execution as the processing logic is to be executed by way of a single node i.e., the complex node.

Presently, the graph-based models implement and store data and processing logic separately and processing logic is executed on the data by retrieving the data from the graph-based model. Therefore, such execution of processing logic is time-intensive and cost-intensive. In addition, such retrieval of sensitive and confidential data is undesirable. On the contrary, the executable graph-based model disclosed herein implements data and processing logic as nodes (such as vertex nodes, edge nodes, overlay nodes, or the like). Hence, the data is not required to be retrieved from the executable graph-based model. Therefore, the data is not compromised. Further, the conventional graph-based models do not have a high-level node structure. Therefore, the processing logic is to be executed on each node separately which adds to the time and cost associated with the execution of the processing logic. However, the executable graph-based model disclosed herein allows for the creation of complex nodes (e.g., a combination of nodes), where an overlay node that includes processing logic to be executed on the nodes may be associated with the complex node. Thus, the processing logic is executed exclusively on the complex node. Hence, the executable graph-based model is simplified and the time and cost associated with the execution of the processing logic is optimized.

Notably, the present disclosure allows for the creation and maintenance of complex nodes within the executable graph-based model of the overlay system. Each complex node is formed based on a combination of a set of nodes of similar or dissimilar node-types and behaviors. This allows the complex node to exhibit a high-level node behavior that is a culmination of node behaviors of each node of the set of nodes. Thus, the complex nodes simplify a previously complex structure of the executable graph-based model. Based on an association of an overlay node with the complex node, processing logic associated with the overlay node may be executed on the set of nodes included in the complex node. Hence, the overlay node is required to be coupled only with the complex node to be logically associated with each of the set of nodes. Such a use of the complex node allows the overlay node to be associated with only one node (i.e., the complex node) which simplifies the structure of the executable graph-based model. In another instance, a frequently executed operation may use the set of nodes. Therefore, creating the complex node based on the set of nodes allows for easy retrieval and execution of the processing logic using the set of nodes as opposed to complicated and time-consuming separate retrieval of each node and processing logic that is required for the execution of the operation. Hence, time complexity and cost complexity for execution of the processing logic is significantly reduced. In addition, a user of the overlay system is presented, via a user device associated with the overlay system, with the complex node and hence, is required to access the complex node only to access any of the set of nodes for the execution of the processing logic. Therefore, user interaction with the overlay system is convenient and seamless.

### Figure Description:

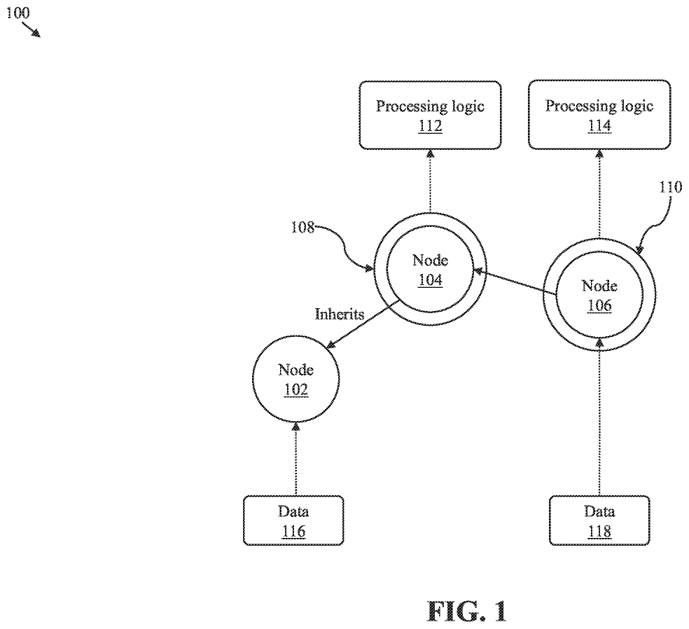

FIG. 1 is a graph that illustrates a composition of an executable graph-based model 100, in accordance with an embodiment of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

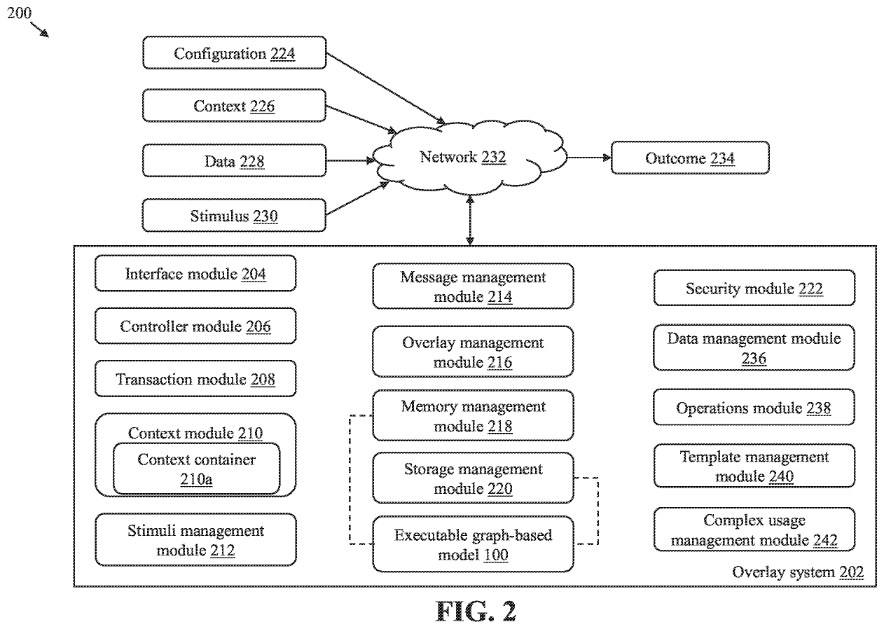

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, in accordance with an embodiment of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a message management module 214, an overlay management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes a data management module 236, an operations module 238, a template management module 240, and a complex usage management module 242. In some embodiments, all the modules of the overlay system 202 except for the executable graph-based model 100 may collectively form processing circuitry that facilitate creation and maintenance of complex nodes within the overlay system 202. A complex node refers to a high-level node in the executable graph-based model 100. The complex node is a combination of a set of nodes of the executable graph-based model 100. The complex node exhibits features and capabilities of the set of nodes encompassed therein. The complex node is created by executing a set of operations, including a join operation or a merge operation, on the set of nodes. Throughout the description, the maintenance of the complex nodes refers to use of the complex node and decomposition of the complex node into the set of nodes composed therein.

The overlay system 202 may include suitable logic, circuitry, interfaces, and/or code, executable by the circuitry, that may be configured to facilitate the creation and maintenance of complex nodes in the executable graph-based model 100. The complex nodes may be created to avail complex and advanced node behaviors of the plurality of nodes within the executable graph-based model 100. Notably, node behavior of a node refers to features and functionalities associated with the node. The executable graph-based model 100 may include a vertex node, an edge node, a role node, and an overlay node. The vertex node may have a vertex node behavior which indicates that the vertex node is configured to store data associated with the overlay system 202. The edge node may have an edge node behavior which indicates that the edge node is configured to couple two or more vertex nodes. The role node may have a role node behavior which indicates that the role node is configured to define an association of a corresponding node with another node of the executable graph-based model 100. The overlay node may have an overlay node behavior which indicates that the overlay node is configured to execute corresponding processing logic on a node associated therewith. Further, node behavior of a complex node depends on node behaviors of each node of the set of nodes. In an instance, when the node behavior of at least one node of the set of nodes is the edge node behavior, the complex node may be a complex edge node with the edge node behavior. In another instance, when the node behavior of each node of the set of nodes is the vertex node behavior, the complex node may be a complex vertex node with the vertex node behavior. In another instance, when the node behavior of each node of the set of nodes is the overlay node behavior, the complex node may be a complex overlay node with the overlay node behavior.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction (such as a merge operation, a join operation, or the like) to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating the creation and maintenance of the complex nodes in the overlay system 202. That is say that one or more contexts of the set of defined contexts are indicative of the one or more operations to be executed for performing the creation and maintenance of the complex nodes in the overlay system 202. The set of defined contexts may include a complex node creation context, a complex node modification context, a complex node deletion context, and a rollback context. The complex node creation context is indicative of a first set of operations for the creation of the complex node. The complex node is created by combining the set of nodes by executing the first set of operations on the set of nodes. The complex node modification context is indicative of a second set of operations for modification of the complex node. The complex node is modified by executing the second set of operations to add a node to the set of nodes in the complex node or eliminate a node from the set of nodes included in the complex node. In addition, the complex node may be modified by executing one or more operations using the complex node. The complex node deletion context is indicative of a third set of operations for deletion of the complex node. The deletion of the complex node refers to decomposition of the complex node into the set of nodes such that each of the set of nodes exhibits a state that is achieved based on the execution of one or more operations on the complex node. The rollback context is indicative of a rollback operation for the decomposition of the complex node into the set of nodes such that each of the set of nodes regains corresponding original state, where original state refers to a state of a node before the creation of the complex node. A set of operations associated with the creation and maintenance of the complex node is executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 238 of the overlay system 202.

The message management module 214 may include suitable logic, circuitry, interfaces, and/or code, executable by the circuitry, configured to manage all data or information associated with data (e.g., in form of messages) communicated within the overlay system 202 (e.g., the data 228) for a given communication network implemented by way of the executable graph-based model 100. Operations performed by the message management module 214 include data loading, data unloading, data modeling, and data processing operations associated with the generation and communication of messages within the overlay system 202. The message management module 214 is communicatively coupled (e.g., connected either directly or indirectly) to one or more other modules within the overlay system 202 to complete some or all of these operations. For example, the storage of data or information associated with messages is handled in conjunction with the storage management module 220 (as described in more detail below).

The overlay management module 216 may include suitable logic, circuitry, interfaces, and/or code, executable by the circuitry, configured to manage all overlays within the overlay system 202. Operations performed by the overlay management module 216 include overlay storage management, overlay structure modeling, overlay logic creation and execution, and overlay loading and unloading (within the executable graph-based model 100). The overlay management module 216 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more of the modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

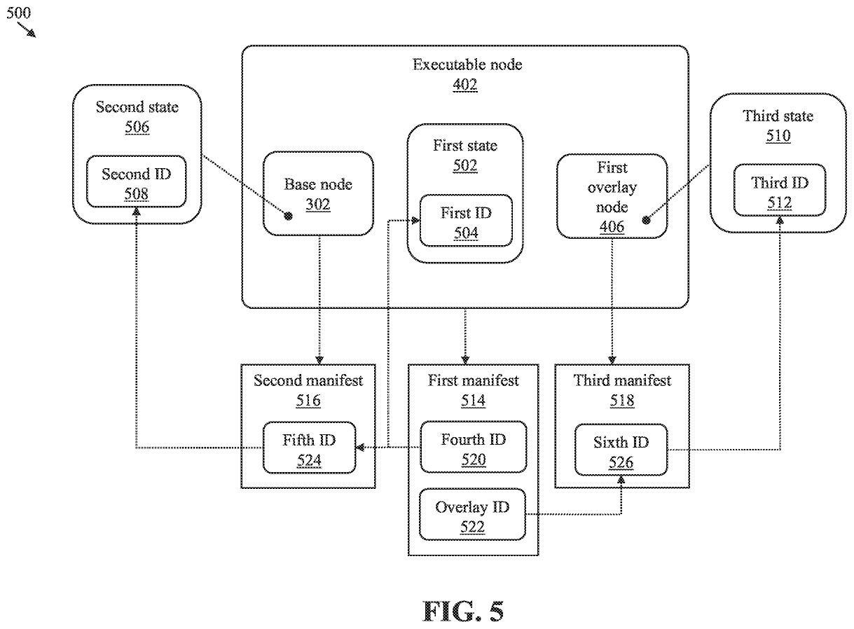

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage manifest states (including manifest template states and manifest instance states) of nodes. Manifest states are described in detail in conjunction with FIG. 5.

The security module 222 may include suitable logic, circuitry, interfaces, and/or code, executable by the circuitry, configured to manage the security of the overlay system 202. This includes the security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the message management module 214 and the overlay management module 216 for managing and executing security-based overlays.

The data management module 236 may include suitable logic, circuitry, interfaces, and/or code, executable by the circuitry, configured to manage all data or information within the overlay system 202 (e.g., the data 228) for a given application. Operations performed by the data management module 236 include data loading, data unloading, data modeling, and data processing. The data management module 236 is communicatively coupled (e.g., connected either directly or indirectly) to one or more other modules within the overlay system 202 to complete some or all of these operations. For example, data storage is handled by the data management module 236 in conjunction with the storage management module 220.

The operations module 238 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like).

The template management module 240 may include suitable logic, circuitry, interfaces, and/or code, executable by the circuitry, configured to enable the overlay system 202 to implement a templated version of one or more nodes of the executable graph-based model 100. The template management module 240 may be configured to create one or more predefined templates in the executable graph-based model 100. The template management module 240 may be further configured to generate one or more node instances of the predefined templates for the implementation of a templated version of the executable graph-based model 100. Notably, the template management module 240 ensures ontology integrity by enforcing the structure and rules of a template when generating instances of the template at run-time. Ontology integrity refers to the consistency, accuracy, and correctness of an ontology. Thus, the template management module 240 ensures that the consistency, accuracy, and correctness of the ontology of the executable graph-based model 100 is maintained while generating the instances of the template at run-time. The template management module 240 may be communicatively coupled (i.e., connected either directly or indirectly) to one or more nodes and/or one or more overlays within the executable graph-based model 100.

The complex usage management module 242 may include suitable logic, circuitry, interfaces, and/or code, executable by the circuitry, configured to facilitate the creation and maintenance of the complex nodes in the overlay system 202. The complex usage management module 242 may be configured to create the complex nodes, modify the complex nodes, delete the complex nodes, and rollback the creation of the complex nodes and/or one or more operations executed on the complex nodes. The complex usage management module 242 may perform the abovementioned operations in conjunction with one or more other modules of the overlay system 202.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model; specifically, the concept of a node. Unlike conventional graph-based systems, all elements (e.g., data, overlays, etc.) within the executable graph-based model (e.g., the executable graph-based model 100) are implemented as nodes. As will become clear, this allows executable graph-based models to be flexible, extensible, and highly configurable.

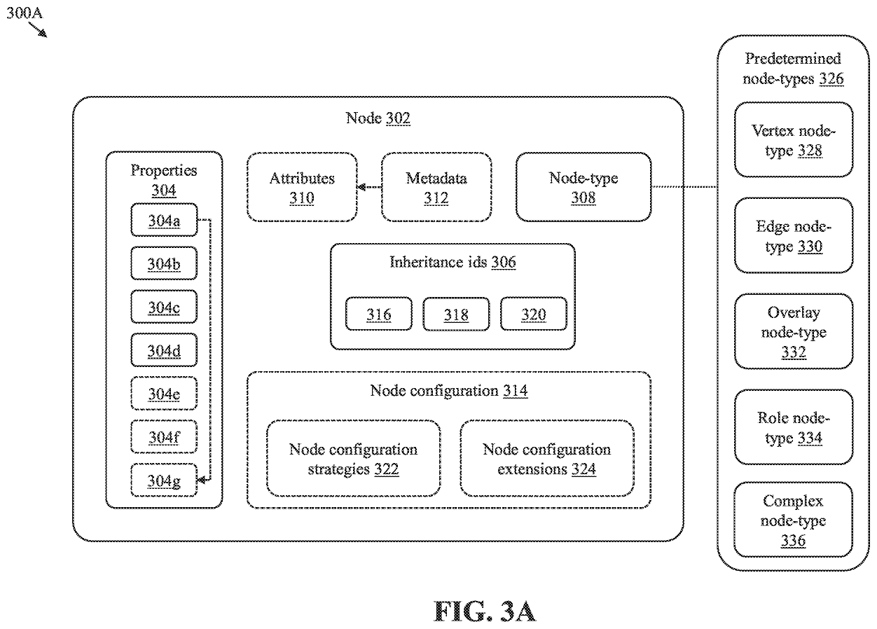

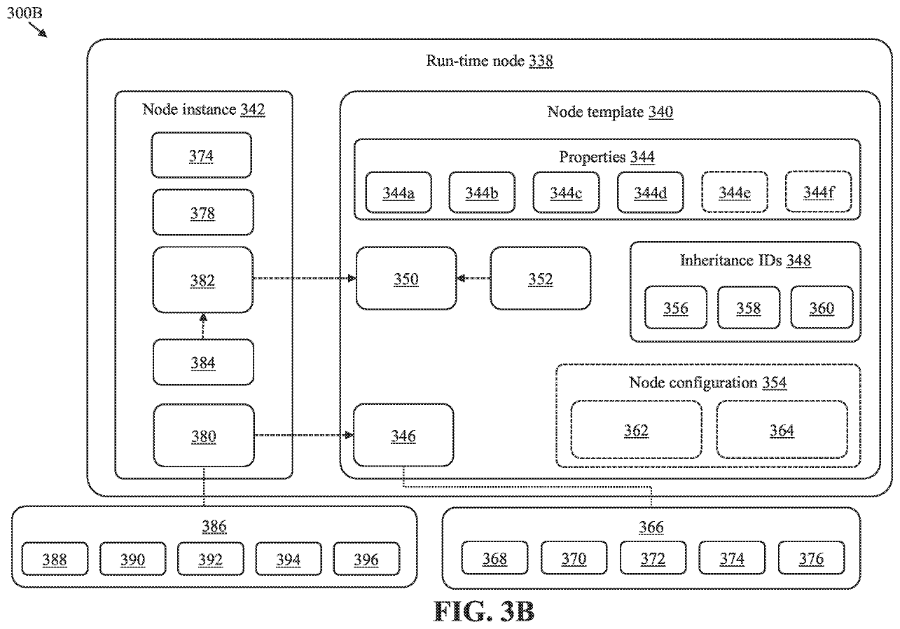

FIG. 3A is a block diagram 300A that illustrates a generic structure of a node 302 within the executable graph-based model 100, in accordance with an embodiment of the present disclosure. Referring to FIG. 3A, the node 302 corresponds to the core structure of the executable graph-based model 100 and forms the foundational building block for all data and processing logic within the executable graph-based model 100. The node 302 includes properties 304, inheritance IDs 306, and a node-type 308. The node 302 optionally includes one or more attributes 310, metadata 312 associated with the attributes 310, and a node configuration 314.

The properties 304 of the node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the node 302 is incremented when the node 302 undergoes transactional change. This allows the historical changes between versions of the node 302 to be tracked by modules or overlays within the overlay system 202. The namespace 304c of the node 302, along with the name 304d of the node 302, is used to help organize nodes within the executable graph-based model 100. That is, the node 302 is assigned a unique name 304d within the namespace 304c such that the name 304d of the node 302 need not be unique within the entire executable graph-based model 100, only within the context of the namespace 304c to which the node 302 is assigned. The node 302 optionally includes one or more icons 304e which are used to provide a visual representation of the node 302 when visualized via a user interface. The one or more icons 304e can include icons at different resolutions and display contexts such that the visualization of the node 302 is adapted to different display settings and contexts. The node 302 also optionally includes one or more labels 304f which are used to override the name 304d when the node 302 is rendered or visualized.

The node 302 supports the concept of inheritance of data and processing logic associated with any other node of the executable graph-based model 100 that is inherited by the node 302. This allows the behavior and functionality of the node 302 to be extended or derived from the inherited node of the executable graph-based model 100. The inheritance IDs 306 of the node 302 indicate the inheritance-based information, which may apply to the node 302. The inheritance IDs 306 comprise a set of Boolean flags which identify the inheritance structure of the node 302. The abstract flag 316 allows the node 302 to support the construct of abstraction. When the abstract flag 316 takes a value ‘true’, the node 302 is flagged as abstract that is to say that it cannot be instantiated or created within an executable graph-based model (e.g., the executable graph-based model 100). Thus, in an instance when the node 302 has the abstract flag 316 set to ‘true’, the node 302 may only form the foundation of other nodes that inherit therefrom. By default, the abstract flag 316 of the node 302 is set to ‘false’. The leaf flag 318 is used to indicate whether any other node may inherit from the node 302. If the leaf flag 318 is set to ‘true’, then no other node may inherit from the node 302 (but unlike an abstract node, a node with the leaf flag 318 set may be instantiated and created within the executable graph-based model 100). The root flag 320 is used to indicate whether the node 302 inherits from any other node. If the root flag 320 is set to ‘true’, the node 302 does not inherit from any other node. The node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the node 302 is used to extend the functionality of the node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332, a role node-type 334, and a complex node-type 336. As will be described in more detail below, a node with the overlay node-type 332 is used to extend the functionality of a node, such as the node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited. A node with the complex node-type 336 refers to a high-level node that is a combination of a set of nodes. The node with the complex node-type 336 is a complex edge node when the node-type of at least one node of the set of nodes is an edge node-type. The node with the complex node-type 336 is a complex vertex node when the node-type of each node of the set of nodes is a vertex node-type. The node with the complex node-type 336 is a complex overlay node when the node-type of each node of the set of nodes is an overlay node-type.

The one or more attributes 310 correspond to the data associated with the node 302 (e.g., the data represented by the node 302 within the executable graph-based model 100 as handled by the data management module 236). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, and a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the node 302 further includes the metadata 312 (e.g., data stored as a name, a confidentiality indicator for indicating data as sensitive and/or confidential, an average processing time required for processing data, or the like) which is associated with either the node 302 or an attribute (for example, the one or more attributes 310) of the node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, then updating the data (e.g., the value) of this shared attribute will be reflected across both nodes.

The node configuration 314 provides a high degree of configurations for the different elements of the node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the node 302, which creates message source IDs. A further example of a concrete node configuration strategy is a versioning strategy, associated with the configuration of the version ID 304b of the node 302, which supports major and minor versioning (depending on the type of transactional change incurred by the node 302). The versioning strategy may be adapted to a native filing system of a user device hosting the overlay system 202 or a third-party data storage (for example, Snowflake®, or the like) associated with the overlay system 202.

FIG. 3B is a block diagram 300B that illustrates a generic structure of a run-time node 338 within the executable graph-based model 100, in accordance with an embodiment of the present disclosure. Referring to FIG. 3B, the run-time node 338 corresponds to the core structure of the executable graph-based model 100 and forms the foundational building block for all data and processing logic within the executable graph-based model 100. The run-time node 338 is shown to include a node template 340 and a node instance 342. The node instance 342 is generated according to the node template 340. The node template 340 forms a data structure for the node instance 342. The run-time node 338 is shown in FIG. 3B is a compositional structure that is generated and executed, at run-time as part of the executable graph-based model 100. In other words, the node template 340 is defined as ‘offline’ and the node instance 342 and the run-time node 338 are run-time structures that are dynamically generated during execution of the executable graph-based model 100.

The node template 340 comprises a predetermined node structure. Further, the node template 340 defines one or more rules that govern the generation of the node instance 342. The node instance 342 is an implementation of the node template 340. In other words, the node instance 342 is generated based on the predetermined node structure and the one or more rules of the node template 340. The node template 340 cannot be modified during the execution but may be modified during offline mode or at rest. During execution, only the node instance 342 of the run-time node 338 may be modified.

The node template 340 includes properties 344, a node-type template 346, inheritance IDs 348, and a set of attribute templates 350. The node template 340 may optionally include metadata 352 and a node configuration 354. The properties 344 of the node template 340 include a unique identifier (ID) 344a, a version ID 344b, a namespace 344c, a name 344d, and optionally include one or more icons 344e and a set of labels 344f. The inheritance IDs 348 comprise an abstract flag 356, a leaf flag 358, and a root flag 360. The node configuration 354 optionally comprises one or more node configuration strategies 362 and/or one or more node configuration extensions 364. FIG. 3B further shows a plurality of predetermined node-type templates 366 of the node-type template 346. The plurality of predetermined node-type templates 366 includes a vertex node-type template 368, an edge node-type template 370, a role node-type template 372, an overlay node-type template 374, and a complex node-type template 376. Further, the node instance 342 includes a unique ID 374, a version ID 378, a node-type instance 380, and a set of attribute instances 382. The node instance 342 may optionally include metadata 384. FIG. 3B further shows a plurality of predetermined node-type instances 386 of the node-type instance 380. The plurality of predetermined node-type instances 386 include a vertex node-type instance 388, an edge node-type instance 390, a role node-type instance 392, an overlay node-type instance 394, and a complex node-type instance 396.

The unique ID 344a is unique for each node template within the executable graph-based model 100. Similarly, the unique ID 374 is unique for each node instance within the executable graph-based model 100. The unique ID 344a and the unique ID 374 are used to register, manage, and reference the node template 340 and the node instance 342, respectively, within the overlay system 202. The version ID 344b of the node template 340 is incremented when the node template 340 undergoes transactional change. Similarly, the version ID 378 of the node instance 342 is incremented when the node instance 342 undergoes transactional change. The namespace 344c of the node template 340, along with the name 344d of the node template 340, is used to help organize node templates within the executable graph-based model 100. That is, the node template 340 is assigned a unique name 344d within the namespace 344c such that the name 344d of the node template 340 need not be unique within the entire executable graph-based model 100, only within the context of the namespace 344c to which the node template 340 is assigned. The node template 340 optionally comprises one or more icons 344e which are used to provide a visual representation of the node template 340. The one or more icons 344e can include icons at different resolutions and display contexts such that the visualization of the node is adapted to different display contexts and settings. The node template 340 also optionally comprises the set of labels 344f which are used to override the name 344d when the node template 340 is rendered or visualized.

The node template 340 supports the software development feature of multiple inheritance by maintaining references (not shown) to zero or more other node templates, which then act as the base of the node template 340. This allows the behavior and functionality of a node template to be extended or derived from one or more other node templates within an executable graph-based model (such as the executable graph-based model 100). The node instance 342 likewise supports multiple inheritance because it is an instance representation of the node template 340. The multiple inheritance structure of the node instance 342 is, however, limited to the corresponding instance realization of the multiple inheritance structure defined by the node template 340, i.e., one node instance 342 is created and managed for each node template 340 defined in the inheritance hierarchy for a node instance of a node template.

The inheritance IDs 348 of the node template 340 provide an indication of the inheritance-based information, which is applicable, or can be applicable, to the node template 340. The inheritance IDs 348 have a description that is similar to the inheritance IDs 306. The abstract flag 356 has a description that is similar to the abstract flag 316, the leaf flag 358 has a description that is similar to the leaf flag 318, and the root flag 360 has a description that is similar to the root flag 320.

All elements within the executable graph-based model 100 are defined as node templates or node instances. The functionality of the node template 340 and the node instance 342 are realized due to the use of the node-type template 346 and the node-type instance 380. The node-type template 346 of the node template 340 is used to extend the functionality of the node template 340 by defining the standard set of capabilities, including data and associated behavior.

The vertex node-type template 368 (also referred to as a data node-type) includes a template of common data structures and functionality related to the ‘things’ modeled in the graph (e.g., the data). The vertex node-type instance 388 includes the common data structures and functionality related to the ‘things’ modeled in the graph based on the vertex node-type template 368. The edge node-type template 370 includes a template of common data structures and functionality related to joining two or more nodes. A node instance having the edge node-type instance 390 may connect two or more nodes and thus the edge node-type instance 390 constructs associations and connections between nodes (for example objects or ‘things’) within the executable graph-based model 100. The edge node-type instance 390 is not restricted to the number of nodes that can be associated or connected by a node having the edge node-type instance 390. The data structures and functionality of the edge node-type instance 390 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The role node-type template 372 is used to define structure, conditions, or the like for establishing a connective relationship between two node instances or node templates. Similarly, the role node-type instance 392 is used to define a connective relationship between two node instances. The overlay node-type template 374 is used to extend the functionality of a node template (e.g., the node template 340) to incorporate processing logic. Similarly, the overlay node-type instance 394 is used to extend the functionality of a node instance (e.g., the node instance 342) to incorporate processing logic.

The complex node-type template 376 is a combination of vertex node-type template, edge node-type template, role node-type template, or overlay node-type template of each of the set nodes that are encompassed therein. Therefore, the complex node-type template 376 stores a data structure that is a combination of data structures of each of the set of nodes encompassed therein. Similarly, the complex node-type instance 396 is a combination of vertex node-type instance, edge node-type instance, role node-type instance, or overlay node-type instance of each node of the set nodes that are encompassed therein. Therefore, the complex node-type instance 396 stores data that is a combination of data of each node of the set of nodes encompassed therein.

The set of attribute templates 350 corresponds to the data defined by the node template 340. For example, the set of attribute templates 350 may define the names and value types (e.g., integer, string, float, etc.) of one or more attributes but not the values of these attributes. The values of the set of attribute templates 350 may be defined by the set of attribute instances 382 of the node instance 342 through one or more values or instance values. For example, the node template 340 may define a string attribute ‘surname’ and the corresponding node instance 342 may assign the instance value ‘Bell-Richards’ to this string attribute. Each attribute instance of the set of attribute instances 382 is associated with an attribute template of the set of attribute templates 350. The node template 340 may define one or more default values for the set of attribute templates 350. The default values correspond to the values that the attributes take if no value is assigned. The metadata 352 (e.g., data stored as a name, a value type, and a value triplet) is associated with either the node template 340 or one or more of the set of attribute templates 350 of the node template 340. Similarly, the node instance 342 also optionally comprises the metadata 352 (e.g., data stored as a name, a value type, and a value triplet) which is associated with either the node instance 342 or one or more of the set of attribute instances 382.

The node configuration 354 provides a high degree of configurability for the different elements of a node template and/or a node instance. An example of a concrete node configuration strategy is an ID strategy, associated with the configuration of the unique ID 344a of the node template 340. A further example of a concrete node configuration strategy is a versioning strategy, associated with the configuration of the version ID 344b of the node template 340 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

It will be apparent to a person skilled in the art that each node of the executable graph-based model 100 has a generic structure that is similar to the node 302 of FIG. 3A or the run-time node 338 of FIG. 3B.

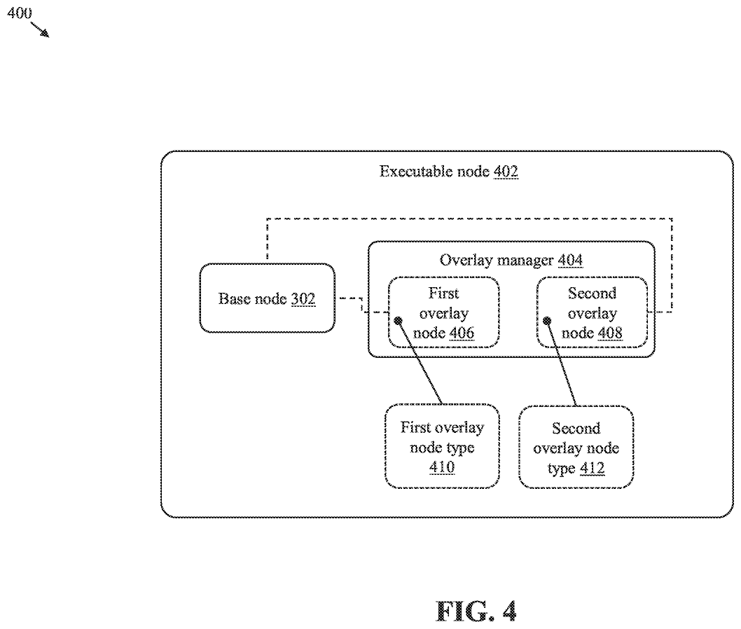

FIG. 4 is a block diagram 400 that illustrates an executable node 402 within the executable graph-based model 100, in accordance with an embodiment of the present disclosure. Referring to FIG. 4, the executable node 402 is shown to include a base node (e.g., the node 302 or the run time node 338) and an overlay manager 404. For the sake of ongoing discussion, the base node corresponds to the node 302, and is hereinafter referred to as the “base node 302”. However, the functionality of the executable node 402 for the base node corresponding to the run-time node 338 may be similar to that for the base node 302.

The overlay manager 404 includes a first overlay node 406 and a second overlay node 408. The executable node 402 provides processing functionality (e.g., processing logic) to the base node 302 via one or more associated overlay nodes (for example, the first and second overlay nodes 406 and 408). Beneficially, the data and processing capability of the base node 302 may be dynamically and significantly extended using the concept of an executable node (for example, the executable node 402). As shown, the first overlay node 406 has a first overlay node-type 410, and the second overlay node 408 has a second overlay node-type 412. Examples of overlay node-type includes, but are not limited to, an encryption overlay node-type.

A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique.

In an instance, when the base node 302 may be a complex node, the first overlay node 406 may be a complex usage overlay node. The complex usage overlay node may include a set of constraints to be adhered to while using the complex node. The set of constraints may include user roles, permissions, or the like. The complex usage overlay node may also include processing logic for implementation of the set of constraints. In addition, the complex usage overlay node also maintains a log (namely, record) of operations executed on the complex node.

Although, the executable node 402 is shown to include the first and second overlay nodes 406 and 408, in other embodiments, the executable node 402 may include any number of overlay nodes, without deviating from the scope of the present disclosure.

The executable node 402 extends the base node 302 (or is a subtype of the base node 302) such that all the functionality and properties of the base node 302 are accessible to the executable node 402. The executable node 402 also dynamically extends the functionality of the base node 302 by associating the overlay nodes maintained by the overlay manager 404 with the base node 302. The executable node 402 may thus be considered a combination of the base node 302 and the first and second overlay nodes 406 and 408. The executable node 402 may be alternatively referred to as a node with overlay(s). Therefore, the executable node 402 acts as a decorator of the base node 302 adding the functionality of the overlay manager 404 to the base node 302.

It will be apparent to a person skilled in the art that the base node 302 refers to any suitable node within the executable graph-based model 100. As such, the base node 302 may be a node having a node-type such as a vertex node-type, an edge node-type, an overlay node-type, a complex node-type, or the like. Alternatively, the base node 302 may be an executable node such that the functionality of the (executable) base node 302 is dynamically extended. In this way, complex and powerful processing functionality can be dynamically generated by associating and extending overlay nodes.

The overlay manager 404 registers and maintains one or more overlay nodes (such as the first overlay node 406 and the second overlay node 408) associated with the base node 302. The assignment of the first and second overlay nodes 406 and 408 to the base node 302 (via the overlay manager 404) endows the base node 302 with processing logic and executable functionality defined within the first and second overlay nodes 406 and 408.

Extending the functionality of a base node through one or more overlay nodes is at the heart of the overlay system 202. As illustrated in FIG. 2, the data (e.g., a vertex node as represented by the base node 302 in FIG. 4) and the functionality that acts upon that data (e.g., an overlay node) can be separated and independently maintained offline, but at run-time, an association between the data node and the overlay node is determined and an executable node is generated (e.g., the executable node 402 shown in FIG. 4).

It will be apparent to a person skilled in the art that functionalities of the first and second overlay nodes 406 and 408 may be performed by a single overlay node that includes processing logic associated with both of the first and second overlay nodes 406 and 408.

It will be apparent to a person skilled in the art that the list of overlay types is not exhaustive and the number of different overlay types that can be realized is not limited. Because an overlay node is itself a node, all functionality of a node described in relation to the base node 302 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the first overlay node 406 or the second overlay node 408, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 404 of the executable node 402 is responsible for executing all overlays registered therewith. The overlay manager 404 also coordinates the execution of all associated overlay nodes. As shown in FIG. 4, the executable node 402 associates the base node 302 with two overlay nodes that is the first overlay node 406 and the second overlay node 408. Thus, the overlay manager 404 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 404 and are associated with an overlay via a node configuration extension for the overlay.

The data and the processing logic associated with one or more overlays of an executable node (for example, the executable node 402) are persistent. The persistent nature of the data and the processing logic are described in detail in conjunction with FIG. 5.

FIG. 5 is a block diagram 500 that illustrates a composition of the executable node 402 that enables persistent storage of data and the processing logic associated therewith, in accordance with an embodiment of the present disclosure.

As described in conjunction with FIG. 4, the executable node 402 includes the base node 302 and one or more overlay nodes (e.g., the first and second overlay nodes 406 and 408). For the brevity of the ongoing description, the persistent storage is explained for the executable node 402 including only the first overlay node 406. One or more operations performed for ensuring the persistence of the first overlay node 406 may be performed for the second overlay node 408 as well.

Referring to FIG. 5, the executable node 402 includes the base node 302 and the first overlay node 406. The executable node 402 has a corresponding first state 502 having a first ID 504. The base node 302 has a second state 506 having a second ID 508, and the first overlay node 406 has a third state 510 having a third ID 512. A manifest (for example, first through third manifests 514-518) is generated for each of the base node 302, the executable node 402, and the first overlay node 406. In an embodiment, the manifests may be generated by the storage management module 220. The first manifest 514 is associated with the executable node 402 and has a fourth ID 520 and an overlay ID 522. The second manifest 516 is associated with the base node 302 and has a fifth ID 524. The third manifest 518 is associated with the first overlay node 406 and has a sixth ID 526. Further, the manifests are stored at respective storage locations that may be centralized or distributed storage locations associated with the overlay system 202. The manifests may be stored by the storage management module 220.

The first state 502 of the executable node 402 includes data required to reconstruct the executable node 402 (e.g., attributes, properties, etc.). The first state 502 of the executable node 402 is persistently stored along with the first ID 504. The first manifest 514 is generated for the executable node 402 and has (i) the fourth ID 520 (which is the same as the first ID 504), (ii) the storage location of the first state 502 of the executable node 402, and (iii) the overlay ID 522 (which is the same as the sixth ID 526). Notably, the fourth ID 520 is the same as the first ID 504 and the fifth ID 524, hence, the first manifest 514 includes the ID of the state of the base node 302 and the executable node 402. Further, the overlay ID 522 is the same as the sixth ID 526 of the state of the first overlay node 406. Therefore, the first manifest 514 may be used to identify and retrieve the states of the base node 302, the executable node 402, and the first overlay node 406. Subsequently, the retrieved states may be used to reconstruct the executable node 402 and the first overlay node 406. In an instance, the executable node 402 may be further extended to include additional overlay nodes. In such an instance, the first manifest 514 may include state IDs of the additional overlay nodes as well. A first manifest state (not shown) is then generated for the first manifest 514 and persistently stored along with the fourth ID 520.

The second state 506 of the base node 302 includes data required to reconstruct the base node 302 (e.g., attributes, properties, etc.) and is persistently stored along with the second ID 508. The second manifest 516 is generated for the base node 302 and has the fifth ID 524 and the storage location of the second state 506 of the base node 302. The second ID 508 of the second state 506 and the fifth ID 524 of the second manifest 516 are the same as the first ID 504 of the first state 502 of the executable node 402 (which is also the same as the fourth ID 520 of the first manifest 514 of the executable node 402). As mentioned above, along with the first state 502, the first manifest 514 may also be used to identify and retrieve the second manifest 516 which in turn may be used to identify the second state 506 of the base node 302. A second manifest state (not shown) is then generated for the second manifest 516 and persistently stored along with the fifth ID 524. Thus, the states, manifests, and manifest states for the executable node 402 and the base node 302 include the same, shared, ID. A shared ID can be used in this instance because the states, manifests, and manifest states are stored separately. The separate storage of the states, manifests, and manifest states exhibit a distributed architecture of the overlay system 202.

The third state 510 of the first overlay node 406 includes data required to reconstruct the first overlay node 406 (e.g., attributes, properties, processing logic, etc.) and is persistently stored along with the third ID 512. The third manifest 518 is generated for the first overlay node 406 and includes the sixth ID 526, which is the same as the third ID 512. Therefore, the first manifest 514 may be further used to identify and retrieve the third manifest 518 which in turn may be used to identify and retrieve the third state 510 of the first overlay node 406. A third manifest state (not shown) is then generated for the third manifest 518 and is persistently stored along with the sixth ID 526.

In operation, when the executable node 402 is to be loaded, the transaction module 208, in conjunction with the storage management module 220, may execute one or more operations to retrieve the first manifest state stored at a known storage location. Based on the first manifest state, the storage management module 220 may re-construct the first manifest 514 which includes the fourth ID 520 which is the same as the fifth ID 524 of the second manifest 516. Based on the fifth ID 524, the storage management module 220 may identify the second manifest state and may generate the second manifest 516 based on which the second state 506 is identified. Subsequently, the base node 302 is loaded and the storage management module 220 may determine that the base node is a node with overlay. Based on the fourth ID 520 (that is the same as the first ID 504 of the first state 502 of the executable node 402) of the first manifest 514, the first state 502 is identified and retrieved. Subsequently, the executable node 402 is loaded. Moreover, based on the overlay ID 522 (that is the same as the sixth ID 526 of the third manifest 518) of the first manifest 514, the third manifest state is identified and the third manifest 518 is generated. Subsequently, based on the sixth ID 526 (that is the same as the third ID of the third state) of the third manifest 518, the third state 510 is identified and retrieved. Based on the third state 510, the first overlay node 406 is reconstructed and loaded in the executable graph-based model 100.

Based on a context of a stimulus (for example, the stimulus 230) associated with the overlay system 202, the processing circuitry (such as the context module 210) may determine an ID which is the same as the fifth ID 524. Based on the determined ID, the processing circuitry (such as the memory management module 218 and the storage management module 220) may identify the second manifest 516. Subsequently, the processing circuitry (such as the memory management module 218 and the storage management module 220) may identify the second state 506 that has the second ID 508 that matches the fifth ID 524. Further, the processing circuitry (such as the memory management module 218 and the storage management module 220) may retrieve the second state 506 associated with the second manifest 516 from a corresponding storage element. Subsequently, the processing circuitry (such as the memory management module 218 and the storage management module 220) may determine, by checking the manifest storage(s) associated with the overlay system 202, whether there is another manifest (such as the first manifest of the executable node 402) with an ID that matches the second ID 508 and the fifth ID 524. Notably, the first manifest 514 includes storage locations of each overlay node (for example, the first overlay node 406) of the executable node 402. Based on the overlay ID 522 included in the first manifest 514 that matches the sixth ID 526 included in the third manifest 518, the processing circuitry (such as the memory management module 218 and the storage management module 220) may identify and retrieve the third manifest 518 from a manifest storage of a plurality of manifest storages of the overlay system 202. Subsequently, the processing circuitry (such as the memory management module 218 and the storage management module 220) may identify the third state 510 that has the third ID 512 that matches the sixth ID 526. Further, the processing circuitry (such as the memory management module 218 and the storage management module 220) may retrieve the third state 510 associated with the third manifest 518 from a corresponding storage element. To determine whether the first overlay node 406 has an overlay node associated therewith, the processing circuitry (such as the memory management module 218 and the storage management module 220) may also perform a check to determine whether any of the plurality of manifest storages of the overlay system 202 includes any other manifest with an ID that matches the sixth ID 526. Since the first overlay node 406 does not have an overlay associated therewith, no other manifest has the ID that matches the sixth ID.

Notably, the manifest (the third manifest 518) of the first overlay node 406 includes a reference (such as an identifier that is common to the second manifest 516 and the third manifest 518, a link, a path, a storage location, or the like) to the second manifest 516 of the base node 302. Therefore, the re-formation of the executable node 402 includes re-creation of the first overlay node 406 prior to re-creation of the base node 302. Subsequently, the first overlay node 406 and the base node 302 are organized by associating the base node 302 with the first overlay node 406 to re-form the executable node 402.

In some embodiments, the first overlay node 406 may not be loaded in case it is not required for executing the operation associated with the stimulus 230. The loaded executable node 402 and the first overlay node 406 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 5 illustrates only a single overlay node, in other embodiments, the executable node 402 may include additional or different overlay nodes (for example, the second overlay node 408). It will also be apparent to a person skilled in the art that only those overlay nodes that are required for responding to the stimulus 230 may be loaded.

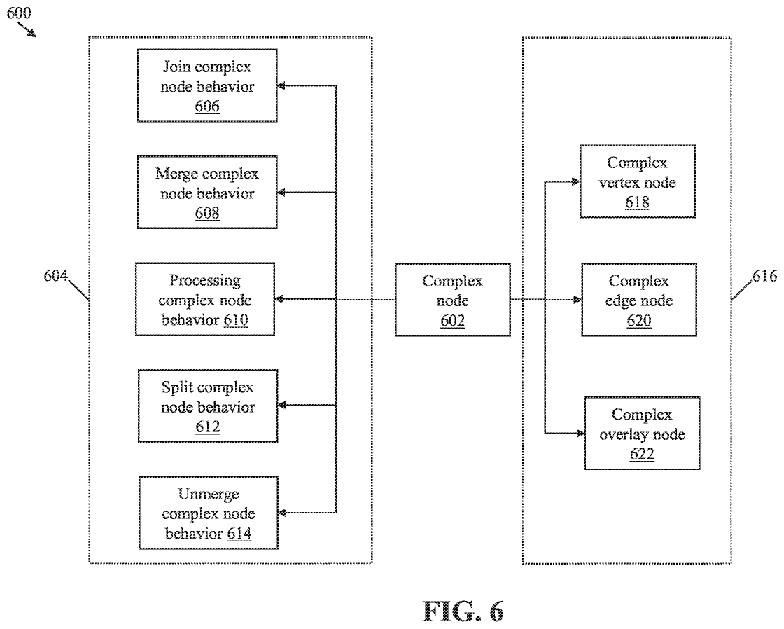

The overlay system 202 described in conjunction with FIGS. 1-5 is used to facilitate the creation and maintenance of the complex nodes in the executable graph-based model 100. A complex node is a high-level structure in the executable graph-based model 100 that not only simplifies the structure of the executable graph-based model 100 but also makes the overlay system 202 user-friendly by abstracting complex tasks from end-users. Various concepts and features associated with the complex nodes are described in detail in conjunction with FIG. 6.

FIG. 6 illustrates a block diagram 600 that depicts features of a complex node, in accordance with an embodiment of the present disclosure. Referring to FIG. 6, shown is a complex node 602 that is a combination of a set of nodes (not shown). The complex node 602 is created and maintained by executing one or more complex node behaviors shown within a dotted box 604. The complex node behavior by way of which the complex node 602 may be created and maintained may include a join complex node behavior 606, a merge complex node behavior 608, a processing complex node behavior 610, a split complex node behavior 612, and an unmerge complex node behavior 614. In other embodiments, the complex node 602 may be created and maintained by way of different complex node behaviors, without deviating from the scope of the disclosure.

The set of nodes based on which the complex node 602 is created include generic nodes, other complex nodes, or a combination thereof. Examples of the generic nodes may include vertex nodes, edge nodes, role nodes, and overlay nodes, which can be base nodes (namely, generic nodes) or run-time nodes (namely, run-time generic nodes). Further, if the complex node 602 is assumed to be a primary complex node, the complex nodes in the set of nodes may be referred to as secondary complex nodes.

The join complex node behavior 606 pertains to a join operation that is executed on the set of nodes to create the complex node 602. The join complex node behavior 606 may be used for the creation of the complex node 602 when the set of nodes includes nodes with same or different node-types. For example, an edge node may be joined with another edge node or a vertex node.

For the execution of the join operation associated with the join complex node behavior 606, the set of nodes may be selected and combined based on a user input received via a user device (not shown) associated with the overlay system 202. Based on the selection of the set of nodes, the set of nodes is encapsulated within a logical boundary that forms the complex node 602. Notably, a node level structure of each node (as shown in FIGS. 3A and 3B) of the set of nodes is logically included in the complex node 602 and each node of the set of nodes persists in the executable graph-based model 100. Hence, each node of the set of nodes may be used for creation of one or more other complex nodes. Further, when each node of the set of nodes may be a run-time node, the join complex node behavior 606 may be used to create a complex node template and a complex node instance for the complex node 602. In such a scenario, the complex node 602 is a run-time complex node and includes the complex node template, that is a combination of node templates of the set of nodes or a node template that is common/identical for each of set of nodes, and the complex node instance, that is a combination/join of node instances of the set of nodes.

To summarize, the join complex node behavior 606 may be used to create the complex node 602 when the set of nodes includes nodes with same or different node-types/node behaviors. When the set of nodes includes the nodes with the same node-types, the complex node 602 is created by way of the join complex node behavior 606 in case the logical structure of the set of nodes is to be persisted and re-used within the executable graph-based model 100.

The merge complex node behavior 608 pertains to a merge operation that is executed on the set of nodes to create the complex node 602. The merge complex node behavior 608 may be used for the creation of the complex node 602 when the set of nodes includes nodes with same/identical node-types. For example, an edge node may be merged only with another edge node, a vertex node may be merged only with another vertex node, an overlay node may be merged only with another overlay node, and so on.

For the execution of the merge operation associated with the merge complex node behavior 608, a master node may be selected by the processing circuitry (such as the complex usage management module 242) based on a user input received via the user device associated with the overlay system 202. Based on the selection of the master node, remaining nodes of the set of nodes are rendered as slave nodes. Subsequently, the slave nodes are merged into the master node such that a composition of the master node takes priority over compositions of the slave node. A composition of a node corresponds to a plurality of attribute values for a plurality of attributes associated therewith. For the sake of brevity, the plurality of attributes of the node (for example, the base node 302, the run-time node 338, or the like) is assumed to include each element of the base node 302 and the run-time node 338 illustrated in FIGS. 3A and 3B, respectively.

Notably, the complex node 602 that is created based on the set of nodes that are base nodes is also a base node. Further, in an instance when each node of the set of nodes has an identical/same node template, the complex node 602 is created based on the merge complex node behavior 608. In such a scenario, the complex node 602 is a run-time complex node and includes a complex node template that is the same as the node template of the set of nodes, and a complex node instance that is a combination/merge of node instances of the set of nodes. In an instance, when the node templates of one or more nodes of the set of nodes may have different versions, a primary version of the node template may be selected by the processing circuitry (such as the complex usage management module 242) based on the user input received via the user device associated with the overlay system 202. The primary version of the node template may act as the complex node template of the complex node 602.

The processing complex node behavior 610 pertains to a join operation or a merge operation that is performed on the set of nodes to create the complex node 602 which is a complex overlay node, where each node of the set of nodes is an overlay node. In an instance, when the set of nodes includes logically similar processing logic, the complex node 602 is created by way of the processing complex node behavior 610 such that the set of nodes are combined/merged by executing a merge operation. In another instance, when one or more overlay nodes of the set of nodes include processing logic that is logically different from the processing logic of remaining overlay nodes of the set of nodes, the complex node 602 is created by way of the processing complex node behavior 610 such that the set of nodes are combined/joined by executing a join operation. The complex node 602 this is created by way of the processing complex node behavior 610 includes complex processing logic that is the combination of the processing logic of the set of nodes.

Throughout the description a complex node that includes a set of nodes is also referred to as a primary complex node, where the set of nodes may include nodes, executable nodes, and complex nodes.

In some embodiments, the complex node 602 may be required to be decomposed into the set of nodes encompassed therein. In such embodiments, a rollback operation may be executed on the complex node 602 for performing the decomposition thereof into the set of nodes. In an instance, when the complex node 602 is created by way of the join complex node behavior 606, the rollback operation is performed on the complex node 602 by way of the split complex node behavior 612. In another instance, when the complex node 602 is created by way of the merge complex node behavior 608, the rollback operation is performed on the complex node 602 by way of the unmerge complex node behavior 614.

For execution of the rollback operation on the complex node 602 by way of the split complex node behavior 612, the logical boundary forming the complex node 602 is dissolved. Consequently, the set of nodes encompassed within the complex node 602 is exposed within the executable graph-based model 100. Notably, since the complex node 602 is formed by way of the join complex node behavior 606, the logical structure of each node of the set of nodes persists. Therefore, the operations performed on the complex node 602 are directly performed on a relevant node of the set of nodes. Hence, when the complex node 602 is decomposed, each of the set of nodes is exposed in the executable graph-based model 100 in a corresponding updated state. The updated states of the set of nodes refers to a state that is generated based on one or more modifications to an original/initial state of the set of nodes for the execution of the operations performed on the complex node 602.

For execution of the rollback operation on the complex node 602 by way of the unmerge complex node behavior 614, a history record of the set of nodes is required to be maintained by the processing circuitry (such as the complex usage management module 242). The history record may include original/initial states of each node of the set of nodes. Further, the history record may also include a log of operations performed on the complex node 602. During the execution of the rollback operation on the complex node 602, the history record is used by the processing circuitry (such as the complex usage management module 242) to unmerge the complex node 602 such that each of set of nodes are re-instantiated in corresponding original states. In some embodiments, each operation of the log of operations performed on the complex node 602 may be mapped to one or more corresponding nodes of the set of nodes. In such embodiments, each of the set of nodes may be re-instantiated in an updated state that reflects the operations executed on the set of nodes by way of the complex node 602. In some embodiments, when the history record of the complex node 602 is not maintained, the set of nodes may be re-instantiated only in corresponding original states.

Having discussed the creation and decomposition of the complex node 602, the description now moves towards types of complex nodes in the executable graph-based model 100. A type of the complex node 602 is determined by the processing circuitry (such as the complex usage management module 242) based on node-types of each node of the set of nodes. As shown within a dotted box 616, the complex node 602 may be the complex vertex node (hereinafter, the complex vertex node 618), the complex edge node (hereinafter, the complex edge node 620), and the complex overlay node (hereinafter, the complex overlay node 622).

The complex vertex node 618 is a combination of vertex nodes and exhibits properties and behavior of vertex nodes combined therein. The complex node 602 may be complex vertex node 618 when each node of the set of nodes is a vertex node. The complex edge node 620 is a combination of one or more vertex nodes and at least one edge node. The complex edge node 620 exhibits properties and features of each of the one or more vertex nodes and at least one edge node. The complex overlay node 622 is a combination of overlay nodes and hence, exhibits properties and functionalities of each overlay node included in the set of nodes. The complex node 602 may be complex overlay node 622 when each node of the set of nodes is an overlay node. That is to say that, the complex node 602 may be used to execute processing logic associated with each of the set of nodes. Additionally, the complex node 602 may be used to access process data associated with each of the set of nodes.

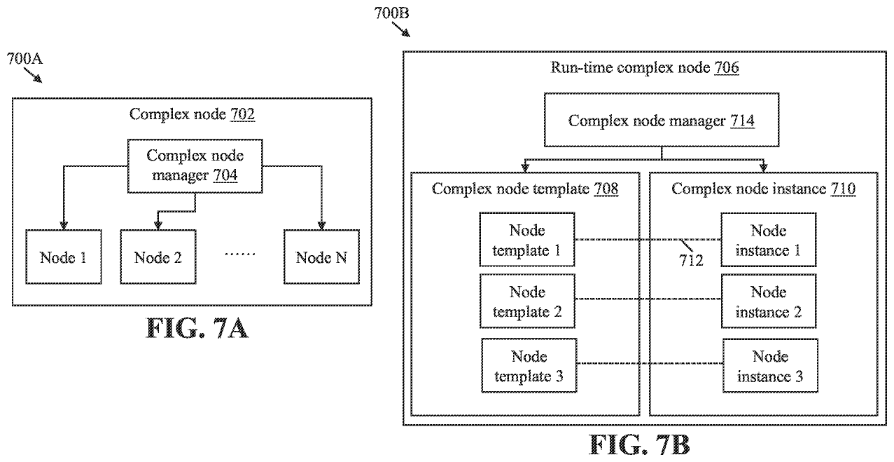

Notably, the complex node 602 has a structure that is a combination of structures of each of the set of nodes. Additionally, the structure of the complex node 602 also depends on the set of nodes being a base node or a run-time node. The structure of a complex node (for example, the complex node 602) is described in detail in conjunction with FIGS. 7A and 7B.

FIG. 7A is a block diagram 700A that illustrates a structure of a complex node 702, in accordance with an embodiment of the present disclosure. The complex node 702 is assumed to be created by way of the join complex node behavior 606. Notably, the complex node 702 corresponds to the complex node 602 when the complex node 602 is a base node. Referring to FIG. 7A, the complex node 702 includes a complex node manager 704 that is configured to maintain a record of each node of the set of nodes that is encompassed within the complex node 702.

As shown, the complex node 702 includes a set of nodes including node 1 through node N. The complex node manager 704 may maintain a record of the set of nodes including ‘Node 1’, ‘Node 2’, and so on till ‘Node N’, such that the complex node manager 704 updates the record based on any modification performed on the complex node 702. The modification to the complex node 702 may include an inclusion or an exclusion of one or more nodes in/from the complex node 702. The modification to the complex node 702 may further include one or more changes/modifications made to the set of nodes.

The complex node manager 704 may be further configured to re-direct a stimulus (for example, the stimulus 230) received by the processing circuitry (such as the controller module 206) to one or more nodes of the set of nodes towards which the stimulus may be directed. In an example, the stimulus may be required to be processed by executing an operation on ‘Node 2’. In such an example, when the stimulus is communicated by the processing circuitry (such as the stimuli management module 212) to the complex node 702, the complex node manager 704 may re-direct the stimulus to ‘Node 2’ for execution of the operation associated with the stimulus.

FIG. 7B is a block diagram 700B that illustrates a structure of a run-time complex node 706, in accordance with an embodiment of the present disclosure. The run-time complex node 706 is assumed to be created by way of the join complex node behavior 606. Notably, the run-time complex node 706 corresponds to the complex node 602 when the complex node 602 is a run-time node. The run-time complex node 706 is a combination of a set of nodes, where each of the set of nodes is a run-time node.

The run-time complex node 706 includes a complex node template 708 and a complex node instance 710. The complex node template 708 corresponds to a dynamic node template that is created by executing a join operation on node templates of each node of the set of nodes. In an instance, when each node of the set of nodes include an identical/common node template, the identical or common node template is determined by the processing circuitry (such as the complex usage management module 242) to be the complex node template 708.

The complex node instance 710 corresponds to a dynamic node instance that is created by executing another join operation on node instances of each node of the set of nodes. Each node instance included in the complex node instance 710 includes a reference to a corresponding node template in the complex node template 708. For example, as shown a ‘Node instance 1’ includes a reference (as shown by way of a dashed line 712) to a ‘Node template 1’. The complex node template 708 and the complex node instance 710, collectively, form the run-time complex node 706.

The run-time complex node 706 further includes a complex node manager 714 that is the same as the complex node manager 704. The complex node manager 714 further includes a mapping between the node templates included in the complex node template 708 and the node instances included in the complex node instance 710. The complex node manager 714 is configured to redirect a stimulus to a relevant node instance which includes a reference to a corresponding node template. The stimulus is subsequently processed using the relevant node instance and the corresponding node template that forms a run-time node.

FIGS. 7A and 7B illustrate complex nodes that are combinations of the set of nodes that are base nodes and run-time nodes, respectively, and are created by way of the join complex node behavior 606. It will be apparent to a person skilled in the art a complex node that is created based on the set of nodes having base nodes and by way of the merge complex node behavior 608 may have a structure that is similar to the complex node 702 such that the complex node includes a single node that is a merged node created by merging the set of nodes. Similarly, the complex node (namely, the run-time complex node) that is created based on a set of run-time nodes and by way of the merge complex node behavior 608 may have a structure that is similar to the run-time complex node 706. The run-time complex node, that is created based on the merge complex node behavior 608, includes a single run-time node that is a merged run-time node created by merging node instances of each node of the set of nodes. The merged node instance is an implementation of a common node template of the set of nodes.

A complex node (for example, the complex nodes 602, 702, and 706) is stored by the processing circuitry (such as the memory management module 218 and the storage management module 220) by storing each node of the set of nodes. Therefore, for loading the complex node each of the set of nodes is required to be loaded. Such loading of the set of nodes is performed by executing a single transaction for loading the complex node.

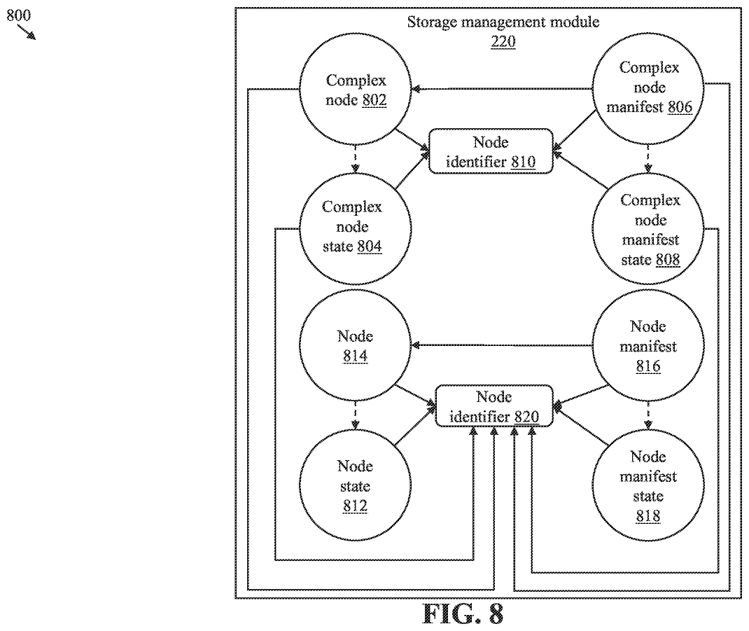

FIG. 8 is a schematic diagram 800 that illustrates a mechanism for storage and loading of a complex node 802, in accordance with an embodiment of the present disclosure. The complex node 802 corresponds to the complex node 602 which is the base node. As mentioned previously, a complex node (for example, the complex node 802) is a combination of a set of nodes. Therefore, for storage and loading of the complex node, each node of the set of nodes is stored and loaded. As shown, the mechanism of the storage and loading of the complex node 802 is encompassed within the functionalities performed by the storage management module 220. The storage management module 220 may perform such storage and loading of the complex node 802 with the controller module 206 and the memory management module 218.

Referring to FIG. 8, as shown, the complex node 802 is associated with a complex node state 804 that includes information to re-create the complex node 802. That is to say, the complex node state 804 includes an ID (e.g., a node identifier) associated with each node of the set of nodes. The processing circuitry (such as the memory management module 218 and the storage management module 220) is configured to create the complex node state 804. The complex node state 804 is stored in a storage location associated with the overlay system 202. The processing circuitry (such as the memory management module 218 and the storage management module 220) is configured to create a complex node manifest 806 that has the storage location of the complex node state 804. Subsequently, the processing circuitry (such as the memory management module 218 and the storage management module 220) is configured to create a complex node manifest state 808 that includes information to re-create the complex node manifest 806. The processing circuitry (such as the memory management module 218 and the storage management module 220) is configured to store the complex node manifest state 808 in a manifest storage of the overlay system 202. As shown, each of the complex node 802, the complex node state 804, the complex node manifest 806, and the complex node manifest state 808 are associated with a same node identifier 810.

The processing circuitry (such as the memory management module 218 and the storage management module 220) is configured to create a node state 812 for a node 814 of the set of nodes. The node state 812 includes information to re-create the node 814. The node state 812 is stored by the processing circuitry (such as the memory management module 218 and the storage management module 220) at a storage location associated with the overlay system 202. Subsequently, the processing circuitry (such as the memory management module 218 and the storage management module 220) may generate a node manifest 816 that includes the storage location of the node state 812. Subsequently, the processing circuitry (such as the memory management module 218 and the storage management module 220) creates a node manifest state 818 that includes information to re-create the node manifest 816. The processing circuitry (such as the memory management module 218 and the storage management module 220) is configured to store the node manifest state 818 in the manifest storage of the overlay system 202. As shown, each of the node state 812, the node 814, the node manifest 816, and the node manifest state 818 are associated with a same node identifier 820. In addition, the node identifier 820 is also associated with each of the complex node 802, the complex node state 804, the complex node manifest 806, and the complex node manifest state 808.

In operation, the processing circuitry (such as the controller module 206) may be configured to receive a stimulus (for example, the stimulus 230). A context of the stimulus may be indicative of the node identifier 810 of the complex node 802. Therefore, the processing circuitry (such as the controller module 206, the memory management module 218, and the storage management module 220) may determine whether the complex node 802 is loaded in the executable graph-based model 100. In an instance, the processing circuitry (such as the controller module 206, the memory management module 218, and the storage management module 220) may determine that the complex node 802 is not loaded in the executable graph-based model 100. In such an instance, based on the node identifier 810, the complex node state 804 may be retrieved as described in conjunction with FIG. 5. As mentioned previously, the complex node state 804 includes identifier of each node of the set of nodes. Therefore, the node identifier 820 is retrieved from the complex node state 804. Subsequently, the node 814 is loaded based on the node identifier 820 as described in conjunction with FIG. 5. The remaining nodes of the set of nodes are loaded in the executable graph-based model 100 in a similar manner. The loading of the set of nodes results in loading of the complex node 802.

For the sake of brevity, a single node of the set of nodes is shown in FIG. 8. It will be apparent to a person skilled in the art that remaining nodes of the set of nodes may be stored and loaded in a similar manner.

FIG. 8 is described with an assumption that the complex node 802 is created by way of the join complex node behavior 606. In instances, when the complex node 802 is created by way of the merge complex node behavior 608, a merged node that forms the complex node 802 is stored and loaded in a manner that is described in conjunction with FIG. 5.

Notably, FIG. 8 illustrates a scenario for loading of the complex node 802 that is a combination of the set of nodes, where each node of the set of nodes corresponds to a base node. The description now moves towards storage and loading of a run-time complex node that is a combination of run-time nodes.

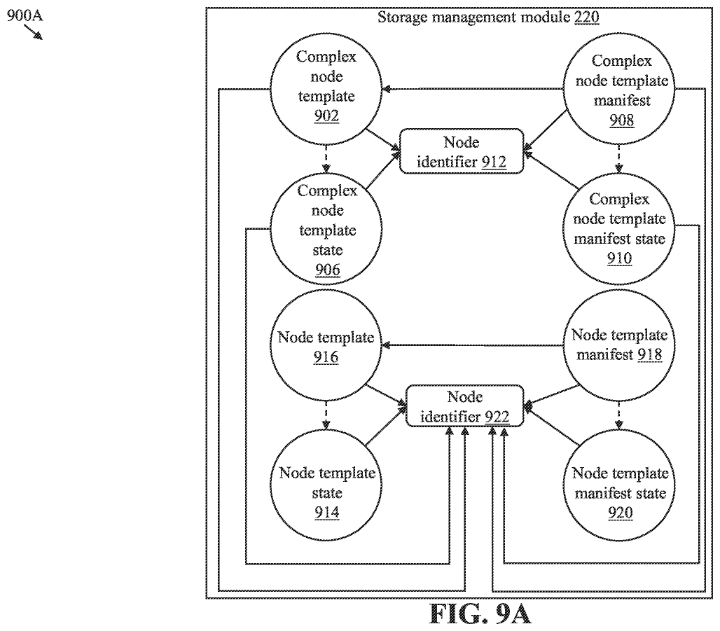

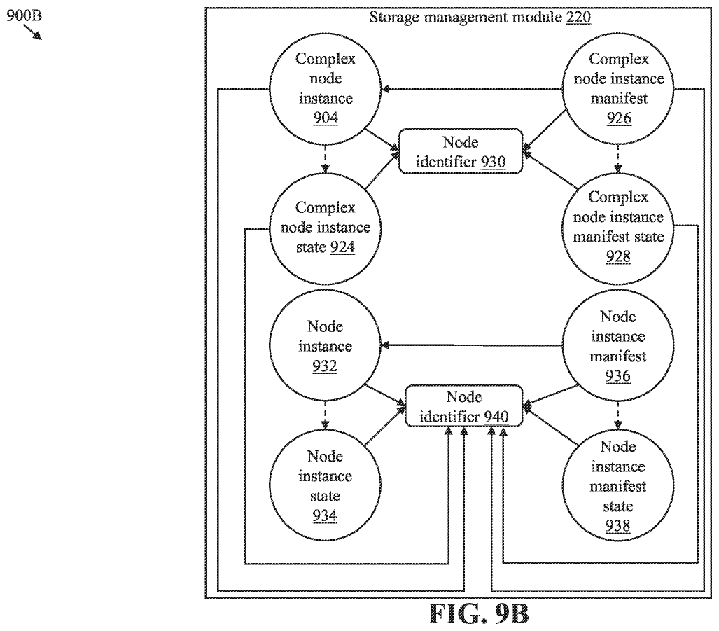

FIGS. 9A and 9B are schematic diagrams 900A and 900B that, collectively, illustrate a mechanism for storage and loading of a run-time complex node (for example, the run-time complex node 706), in accordance with an embodiment of the present disclosure. The run-time complex node includes a complex node template 902 (shown in FIG. 9A) and a complex node instance 904 (shown in FIG. 9B) that is an implementation of the complex node template 902. The complex node template 902 and the complex node instance 904 are created dynamically by the processing circuitry (such as the memory management module 218 and the storage management module 220). The complex node template 902 and the complex node instance 904 are stored and loaded by the processing circuitry (such as the memory management module 218 and the storage management module 220). As shown in FIGS. 9A and 9B, a mechanism of storage and loading of the complex node template 902 and the complex node instance 904 is encompassed within the functionalities performed by the storage management module 220. The storage management module 220 may perform such storage and loading of the complex node template 902 and the complex node instance 904 with the controller module 206 and the memory management module 218.

Referring to FIG. 9A, as shown, the complex node template 902 is associated with a complex node template state 906 that includes information to re-create the complex node template 902. That is to say, the complex node template state 906 includes an ID (e.g., a node identifier) associated with node template of each associated run-time node. The complex node template state 906 is created for the complex node template 902 by the processing circuitry (such as the memory management module 218 and the storage management module 220). The complex node template state 906 is stored in a storage location associated with the overlay system 202. The processing circuitry (such as the memory management module 218 and the storage management module 220) is configured to create a complex node template manifest 908 that has the storage location of the complex node template state 906. Subsequently, the processing circuitry (such as the memory management module 218 and the storage management module 220) is configured to create a complex node template manifest state 910 that includes information to re-create the complex node template manifest 908. The processing circuitry (such as the memory management module 218 and the storage management module 220) is configured to store the complex node template manifest state 910 in the manifest storage of the overlay system 202. As shown, each of the complex node template 902, the complex node template state 906, the complex node template manifest 908, and the complex node template manifest state 910 are associated with a node identifier 912.

The complex node template 902 may be a combination of node templates of each node of the set of nodes. For the sake of brevity, only a single node template (such as node template 902) is depicted in FIG. 9A. The processing circuitry (such as the memory management module 218 and the storage management module 220) is configured to create a node template state 914 for the node template 916. The node template state 914 includes information to re-create the node template 916. The node template state 914 is stored by the processing circuitry (such as the memory management module 218 and the storage management module 220) at a storage location associated with the overlay system 202. Subsequently, the processing circuitry (such as the memory management module 218 and the storage management module 220) is configured to generate a node template manifest 918 that includes the storage location of the node template state 914. Subsequently, the processing circuitry (such as the memory management module 218 and the storage management module 220) is configured to create a node template manifest state 920 that includes information to re-create the node template manifest 918. The processing circuitry (such as the memory management module 218 and the storage management module 220) is configured to store the node template manifest state 920 in the manifest storage of the overlay system 202. As shown, each of the node template state 914, the node template 916, the node template manifest 918, and the node template manifest state 920 are associated with a node identifier 922. In addition, the node identifier 922 is also associated with each of the complex node template 902, the complex node template state 906, the complex node template manifest 908, and the complex node template manifest state 910.

Referring to FIG. 9B, the complex node instance 904 includes a reference to the complex node template 902. As shown, the complex node instance 904 is associated with a complex node instance state 924 that includes information to re-create the complex node instance 904. That is to say, the complex node instance state 924 includes an ID (e.g., a node identifier) associated with node instances of each node of the set of nodes, where the set of nodes is the set of run-time nodes. The processing circuitry (such as the memory management module 218 and the storage management module 220) is configured to create the complex node instance state 924 for the complex node instance 904. The complex node instance state 924 is stored in a storage location associated with the overlay system 202. The processing circuitry (such as the memory management module 218 and the storage management module 220) is configured to create a complex node instance manifest 926 that has the storage location of the complex node instance state 924. Subsequently, the processing circuitry (such as the memory management module 218 and the storage management module 220) is configured to create a complex node instance manifest state 928 that includes information to re-create the complex node instance manifest 926. The processing circuitry (such as the memory management module 218 and the storage management module 220) is configured to store the complex node instance manifest state 928 in the manifest storage of the overlay system 202. As shown, each of the complex node instance 904, the complex node instance state 924, the complex node instance manifest 926, and the complex node instance manifest state 928 are associated with a node identifier 930.

The complex node instance 904 may be a combination of node instances of each node of the set of nodes. For the sake of brevity, only a single node instance (such as node instance 932) is depicted in FIG. 9B. The node instance 932 is an implementation of the node template 916 shown in FIG. 9A. The processing circuitry (such as the memory management module 218 and the storage management module 220) is configured to create a node instance state 934 for the node instance 932. The node instance state 934 includes information to re-create the node instance 932. The node instance state 934 is stored by at a storage location associated with the overlay system 202. Subsequently, the processing circuitry (such as the memory management module 218 and the storage management module 220) is configured to generate a node instance manifest 936 that includes the storage location of the node instance state 934. Subsequently, the processing circuitry (such as the memory management module 218 and the storage management module 220) is configured to create a node instance manifest state 938 that includes information to re-create the node instance manifest 936. The processing circuitry (such as the memory management module 218 and the storage management module 220) is configured to store the node instance manifest state 938 in the manifest storage of the overlay system 202. As shown, each of the node instance 932, the node instance state 934, the node instance manifest 936, and the node instance manifest state 938 are associated with a node identifier 940. In addition, the node identifier 940 is also included in each of the complex node instance 904, the complex node instance state 924, the complex node instance manifest 926, and the complex node instance manifest state 928.

In operation, a stimulus is received by the processing circuitry (such as the controller module 206) that is directed towards the run-time complex node that includes the complex node template 902 and the complex node instance 904. Each of the complex node template 902 and the complex node instance 904 is loaded by the processing circuitry (such as the memory management module 218 and the storage management module 220) in a manner that is similar to the loading of the complex node 802 as described in conjunction with FIG. 8. Notably, the stimulus (for example, the stimulus 230) may include the node identifier (for example the node identifier 930) of the complex node instance 904. As mentioned previously, the complex node instance 904 includes the reference (for example, the node identifier 912) of the complex node template 902. The complex node template 902 is loaded prior to the loading of the complex node instance 904. Also, node instance 932 includes a reference (for example, the node identifier 922) of the node template 902. Consequently, the node template 916 is loaded prior to the loading of the node instance 932.

For the sake of brevity, the complex node template 902 and the complex node instance 904 are shown to include a single node template and a single node instance, respectively. The complex node template 902 and the complex node instance 904 may similarly include node templates and node instances, respectively, of remaining nodes of the set of nodes. It will be apparent to a person skilled in the art the node templates and node instances of remaining nodes may be stored and loaded in a manner that is similar to the storage and loading of the node template 916 and the node instance 932, respectively.

FIGS. 9A and 9B are described with an assumption that the run-time complex node is created by way of the join complex node behavior. In instances, when the run-time complex node is created by way of the merge complex node behavior 608, a corresponding complex node template and a corresponding complex node instance are stored and loaded in a manner that is described in conjunction with FIG. 5 such that the complex node instance includes a reference to the complex node template. The complex node template is loaded prior to the complex node instance.

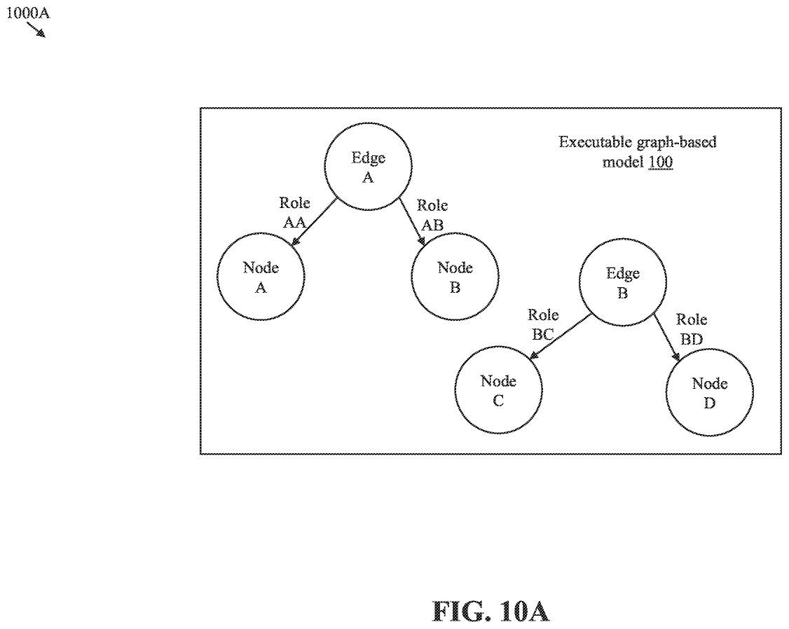

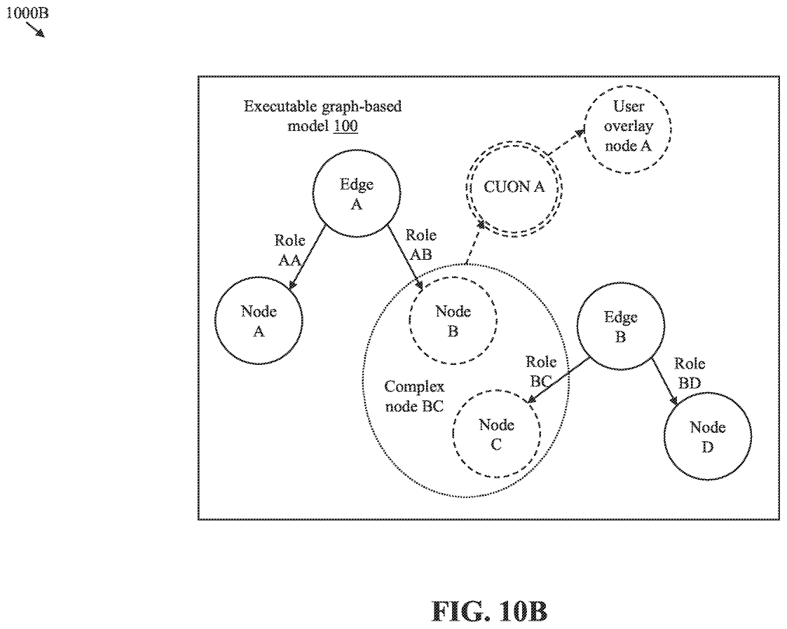

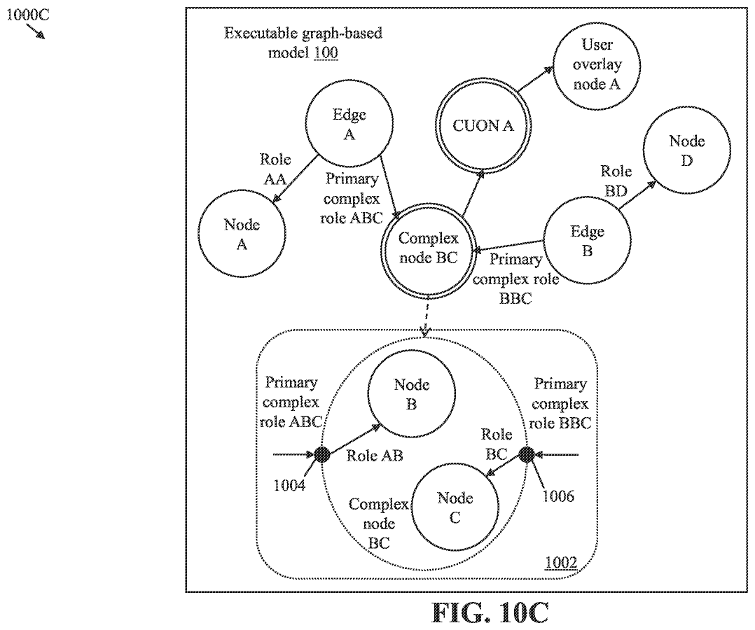

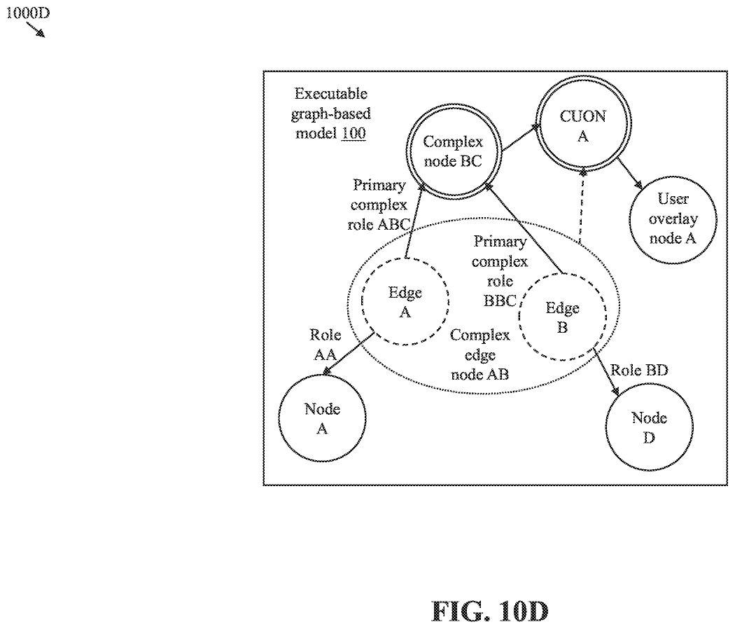

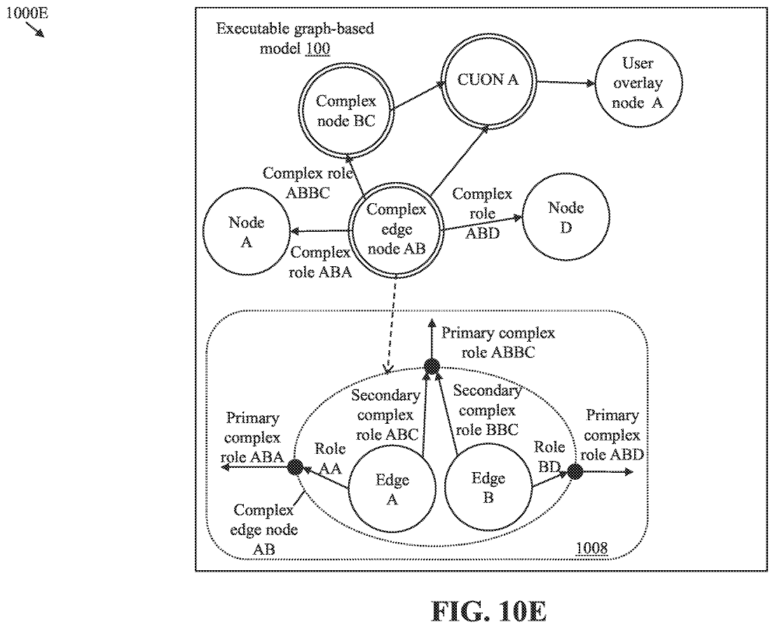

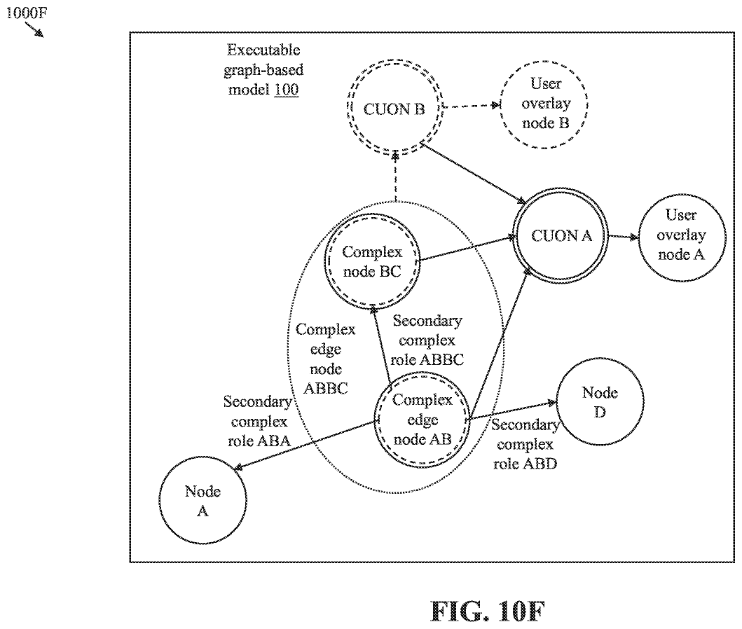

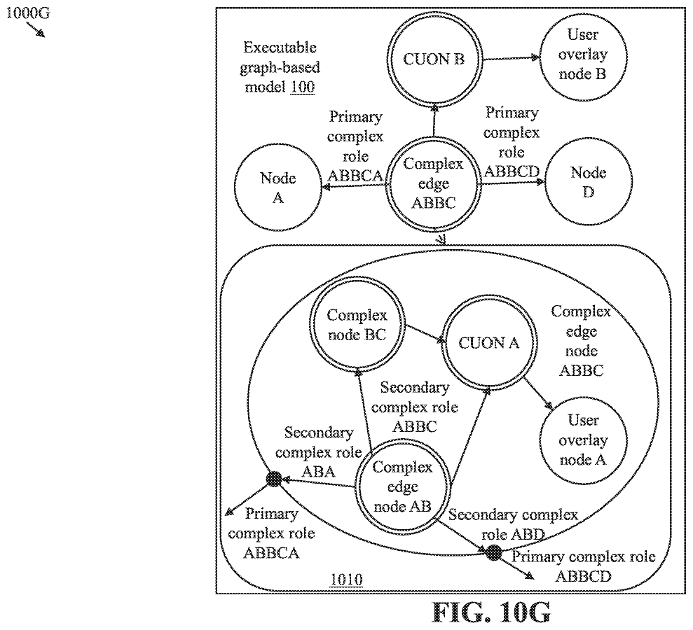

The abovementioned concepts associated with the creation and maintenance of the complex nodes (for example, the complex nodes 602, 702, and 706) are used for creating complex nodes in the executable graph-based model 100. As mentioned previously, a complex node is created by combining a set of nodes, where the set of nodes may include heterogeneous or homogeneous nodes. That is to say that, the set of nodes may include nodes with the same node-type or different node-types. The complex node may be created by way of the join complex node behavior 606 when the set of nodes includes nodes with the same node-type or different node-types. The creation of the complex node (for example, the complex nodes 602, 702, and 706) by way of the join complex node behavior 606 is described in detail in conjunction with FIGS. 10A-10G.

FIGS. 10A-10G are schematic diagrams 1000A-1000G that illustrate creation of complex nodes based on the join complex node behavior 606, in accordance with an embodiment of the present disclosure. FIGS. 10A-10G depict the executable graph-based model 100 at various stages of the creation of complex nodes.

Referring to FIG. 10A, illustrated is the executable graph-based model 100 that includes nodes A and B that are coupled to an edge A. The edge A is associated with the nodes A and B via role nodes AA and AB, respectively. For the sake of brevity, the role nodes AA and AB are represented by way of arrows that couple the nodes A and B, respectively, with the edge A. In practical implementations, the roles AA and AB may be implemented by way of corresponding role nodes.

The executable graph-based model 100 further includes nodes C and D that are coupled to an edge B. The edge B is associated with the nodes C and D via role nodes BC and BD, respectively. For the sake of brevity, the role nodes BC and BD are represented by way of arrows that couple the nodes C and D, respectively, with the edge B. In practical implementations, the roles BC and BD may be implemented by way of corresponding role nodes.

Throughout the description, each node that is represented in a corresponding figure as an inner circle enclosed within an outer circle is an executable node. The inner circle represents its base node, and the outer circle represents an overlay node associated therewith. Further, coupling between a first node and the inner circle of the executable node represents an association between the executable node and the first node. A coupling between the outer circle of the executable node and a second node indicates that the second node is an overlay of the executable node.

The processing circuitry (such as, the controller module 206) may receive a first stimulus (for example, the stimulus 230) associated with the overlay system 202. The first stimulus is indicative of creation of a complex node (namely, a primary complex node) based on a set of nodes including the nodes B and C. The first stimulus may be further indicative of the creation of the complex node by way of the join complex node behavior 606. The processing circuitry (such as the controller module 206, the context module 210, and the stimuli management module 212) may be configured to match a context of the first stimulus with the set of defined contexts. Subsequently, based on the context being a match to the complex node creation context, the processing circuitry (such as the controller module 206, the context module 210, the stimuli management module 212, and the complex usage management module 242) may be configured to identify the nodes B and C in the executable graph-based model 100 for stimulus processing.

Referring to FIG. 10B, illustrated is the schematic diagram 1000B that depicts the nodes B and C by way of dashed circles which indicates that the nodes B and C are identified and selected based on an input that is received as the first stimulus. The processing circuitry (such as the complex usage management module 242) may be configured to determine node-types of each of the nodes B and C (e.g., the set of nodes). In an instance, the processing circuitry (such as the complex usage management module 242) may determine that the nodes B and C are nodes with vertex node-types and hence, the nodes B and C are vertex nodes. The processing circuitry (such as the complex usage management module 242) may further determine that the nodes B and C are generic nodes, where a generic node refers to a node that is not a complex node. The processing circuitry (such as the complex usage management module 242) may also determine that the complex node may be created by way of the join complex node behavior 606. Subsequently, the processing circuitry (such as the complex usage management module 242) may preview a state of the executable graph-based model 100 that is a result of an execution a set of operations, associated with the join complex node behavior 606, on the nodes B and C to create a complex node BC (shown by way of a dotted oval). Notably, the processing circuitry (such as the complex usage management module 242) also previews creation of a complex usage overlay node A (represented in FIGS. 10B-10G as “CUON A”) and the user overlay node A for the maintenance of the complex node BC. Throughout the description, the dashed circles, dashed lines, and dotted ovals indicate that creation thereof is a preview and has not been committed in the executable graph-based model 100. The creation of elements depicted by the dashed circles, dashed lines, and dotted ovals is committed based on a confirmation that indicates acceptance of the preview. Such confirmation may be received from an application program interface (API) or via a user device, associated with the overlay system 202

Subsequently, based on the confirmation, the processing circuitry (such as the complex usage management module 242) is configured to execute a set of operations on the nodes B and C (e.g., the set of nodes) to create a combined node that is a combination of the nodes B and C. The set of operations is associated with the complex node behavior by way of which the complex node is to be created. That is to say that, the processing circuitry (such as the complex usage management module 242) is configured to execute a join operation on the nodes B and C to create a joined node. The combined node pertains to the joined node when the complex node behavior corresponds to the join complex node behavior 606. The joined node is a result of the join operation executed on the nodes B and C. Subsequently, the processing circuitry (such as the complex usage management module 242) is configured to identify, from the set of nodes including the nodes B and C, a subset of nodes that is associated with another set of nodes in the executable graph-based model 100, where the another set of nodes is different from the set of nodes being used for creation of the complex node BC. The nodes B and C are identified as the subset of nodes that are generic nodes and are associated with one or more nodes of the another set of nodes by way of a generic role. A generic role defines an association/relationship by way of which a corresponding generic node (for example, the nodes B and C) is associated with an associated node of the another set of nodes. As shown, the edge A is associated with the node B by way of the role AB (hereinafter, the generic role AB) and the edge B is associated with the node C by way of the role BC (hereinafter, the generic role BC).

Referring now to FIG. 10C, the schematic diagram 1000C is illustrated. For each generic role associated with the nodes B and C, the processing circuitry (such as the complex usage management module 242) is configured to create a primary complex role (implemented by way of a primary complex role node). Each primary complex role defines an association between the complex node BC and one of the edges A and B. Additionally, the primary complex role is mapped to a node of the subset of nodes with which a corresponding generic role is associated. Each primary complex role node points/directs to a corresponding generic role node. As shown within a dotted box 1002 that presents an exploded view of the complex node BC, for the generic role AB of the node B, a primary complex node ABC is created such that the primary complex role ABC is mapped to the node B by way of a mapping point 1004 in the complex node BC, where the mapping point 1004 directs the primary complex role ABC to the generic role AB. Notably, the generic role AB is owned by the edge A. Hence, based on the creation of the primary complex role ABC, the edge A is associated with the complex node BC via the primary complex role ABC. Therefore, the edge A refers to the complex node BC via the primary complex role ABC. Additionally, for the generic role BC of the node C, a primary complex node BBC is created such that the primary complex role BBC is mapped to the node C by way of a mapping point 1006 in the complex node BC, where the mapping point 1006 directs the primary complex role BBC to the generic role BC. Notably, the generic role BC is owned by the edge B. Hence, based on the creation of the primary complex role BBC, the edge B is associated with the complex node BC via the primary complex role BBC. Therefore, the edge B refers to the complex node BC via the primary complex role BBC.

Subsequently, the processing circuitry (such as the complex usage management module 242) is configured to instantiate the complex node BC (namely, the primary complex node BC) in the executable graph-based model 100. The complex node BC refers to the joined node that is created by executing the join operation on the nodes B and C. Further, the processing circuitry (such as the complex usage management module 242) is configured to associate the primary complex roles ABC and BBC, created for the generic roles AB and BC of the nodes B and C, respectively, with the complex node BC. Additionally, the processing circuitry (such as the overlay management module 216 and the complex usage management module 242) is configured to instantiate the complex usage overlay node A. The complex usage overlay node A is associated with the complex node BC such that the complex usage overlay node A is an overlay of the complex node BC. For the maintenance of the complex node BC, the complex usage overlay node A stores a record of current states of the nodes B and C that is included in the complex node BC. The complex usage overlay node A also stores and implements a set of constraints (for example, permissions, roles, or the like) that is to be adhered to while using the complex node BC. The set of constraints includes limitations associated with the complex node BC that is to be followed while using the complex node BC. The complex usage overlay node A may further maintain a log of operations that are performed on the nodes B and C by way of the complex node BC.

In some embodiments, one or more of the set of constraints may be established by associating the complex usage overlay node A with one or more additional overlays (for example, a user overlay, a role overlay, or the like). As shown, the complex usage overlay node A is associated with the user overlay node A which includes processing logic that allows only a specific user associated therewith to use the complex node BC.

In some embodiments, an overlay (for example, the complex usage overlay node A) may be a stateless overlay node or a stateful overlay node. The stateless overlay node is non-persistent in nature and hence is not stored in the storage device associated with the overlay system 202, whereas, the stateful overlay node is persistent within the overlay system 202 and data associated therewith is stored in the storage device associated with the overlay system 202. Data associated with the stateless overlay node is stored along with the complex node (e.g., the complex node BC).

Notably, as shown within the dotted box 1002, the complex node BC is created by way of the join complex node behavior 606, hence, logical structures of the nodes B and C persist. Therefore, an operation that is performed, by way of the complex node BC, on any of the nodes B and C is executed directly on the nodes B and C. Further, since the logical structure of the nodes B and C persist, each of the nodes B and C may be used for a simultaneous creation of another complex node.

In an instance, a second stimulus (for example, the stimulus 230) associated with the overlay system 202 may be received by the processing circuitry (such as the controller module 206). The second stimulus may be indicative of an operation to be executed using the node B. The processing circuitry (such as the complex usage management module 242) may be configured to identify, based on the second stimulus, the complex node BC in the executable graph-based model 100. The processing circuitry (such as the complex usage management module 242) may be configured to determine that the primary complex role ABC is mapped to the node B and hence conforms with the second stimulus. The processing circuitry (such as the complex usage management module 242) may be configured to map the primary complex role ABC to the generic role AB based on association of the primary complex role ABC with the generic role AB at the mapping point 1004. Subsequently, the processing circuitry (such as the complex usage management module 242) may be configured to identify, based on the mapping between the primary complex role ABC and the generic role AB, the node B in the complex node BC using which the operation is to be executed. Once, the node B is identified, the processing circuitry (such as the context module 210, the stimuli management module 212, and the complex usage management module 242) may be configured to re-direct the second stimulus to the node B included in the complex node BC. Based on the re-direction, the processing circuitry (such as the complex usage management module 242) may execute the operation using the node B.

Referring to FIG. 10D, a schematic diagram 1000D is illustrated. The processing circuitry (such as, the controller module 206) may receive a third stimulus that is indicative of creation of another complex node (namely, a primary complex node) based on the edges A and B. The edge A is associated with node A by way of the role AA (hereinafter, the generic role AA) and the complex node BC by way of the primary complex role ABC. The edge B is associated with node D by way of the role BD (hereinafter, the generic role BD) and the complex node BC by way of the primary complex role BBC. A complex edge node AB is created in a manner that is similar to the creation of the complex node BC.

Referring to FIG. 10E, shown is a schematic diagram 1000E. As shown within a dotted box 1008, execution of the set of operations for creating the complex edge node AB includes creation of primary complex roles ABA and ABD for the generic roles AA and BD, respectively as described in conjunction with the creation of the complex node BC. Since the primary complex roles ABC and BBC are associated with edges A and B that is combined to form the complex edge node AB, the primary complex roles ABC and BBC are required to be mapped to corresponding primary complex roles. Therefore, based on the creation of the complex edge node AB, the primary complex roles ABC and BBC form secondary complex roles ABC and BBC, respectively that are associated with the complex edge node AB. Subsequently, a single primary complex role ABBC is created by the processing circuitry (such as the complex usage management module 242) for both the secondary complex roles ABC and BBC. The primary complex role ABBC associates the complex edge node AB with the complex node BC. The primary complex role ABBC is mapped to the edges A and B at a corresponding mapping point. Notably, the edge node A is coupled to the complex node BC and the node A and owns the secondary complex role ABC and the generic role AA. Similarly, the edge node B is coupled to the complex node BC and the node D and owns the secondary complex node BBC and the generic role BD. Therefore, the arrows depicting the generic roles AA and BD, the secondary complex roles ABC and BBC, and the primary complex roles ABA, ABD, and ABBC are shown to be in an outward direction from the complex edge node AB. The primary complex role ABBC points to the complex node BC for each of the edges A and B included in the complex edge node AB. Further, the set of constraints to be adhered to while using the complex node BC is also required to be adhered to while using the complex edge node AB. Additionally, the complex edge node AB is to be used by the same user using the complex node BC. Therefore, the complex usage overlay node A is associated with the complex edge node AB. Subsequently, based on a fourth stimulus (for example, the stimulus 230), an operation to be performed using any of the edges A and B may be performed as described in conjunction with FIG. 10C.

Notably, when the set of nodes to be combined includes complex nodes, such complex nodes are termed as secondary complex nodes. Creation of a complex node based on the secondary complex nodes is described in conjunction with FIGS. 10F and 10G.

Referring now to FIG. 10F, illustrated is a schematic diagram 1000F. The processing circuitry (such as the controller module 206) may receive a fifth stimulus indicative of creation of a complex edge node ABBC based on a set of nodes including the complex node BC and the complex edge node AB. The complex node BC and complex edge node AB are secondary complex nodes that are coupled by way of the primary complex role ABBC which now forms a secondary complex role based on inclusion thereof within the complex edge node ABBC. As mentioned previously, the complex edge node AB is associated with the nodes A and D by way of the primary complex roles ABA and ABD which now forms secondary complex roles ABA and ABD, respectively. Further, a complex usage overlay node B is instantiated that stores a record of the set of nodes including the complex nodes BC and the complex edge node AB that is to be included in the complex edge node ABBC. The complex usage overlay node B also stores and implements a set of constraints (for example, permissions, roles, or the like) that is to be adhered to while using the complex edge node ABBC. The set of constraints includes limitations associated with the complex edge node ABBC that is to be followed while using the complex edge node ABBC. The complex usage overlay node B inherits from the complex usage overlay node A. Hence, the complex usage overlay node B further includes the set of constraints included in the complex usage overlay node A. The complex usage overlay node B may further maintain a log of operations that are performed on the complex nodes BC and AB by way of the complex node ABBC. The complex usage overlay node B is associated with a user overlay node B that includes processing logic that allows only a specific user associated with the overlay system 202 to use the complex edge node ABBC.

Referring now to FIG. 10G, illustrated is the schematic diagram 1000G. As shown within a dotted box 1010 which depicts an exploded view of the complex edge node ABBC. The processing circuitry (such as the complex usage management module 242) may create primary complex roles ABBCA and ABBCD for the secondary complex roles ABA and ABD, respectively. The primary complex roles are created in a manner that is similar to creation of complex nodes as described in conjunction with FIGS. 10A-10E. Also, since the complex usage overlay node A is associated with complex node BC and the complex edge node AB, the complex edge node ABBC also includes the complex usage overlay node A and the user overlay node A. Subsequently, the complex edge node ABBC is created based on the complex node BC and the complex edge node AB and used to perform any operation as described in conjunction with FIGS. 10A-10E. As shown, the complex edge node ABBC is associated with the complex usage overlay node B once the creation of the complex edge node ABBC is committed.

It will be apparent to a person skilled in the art that when the set of nodes includes vertex nodes and one or more edge nodes, the complex node may be created as described in conjunction with FIGS. 10B-10E. Further, it will also be apparent to a person skilled in the art that when the set of nodes includes a set of generic nodes and a set of secondary complex nodes, the complex node may be created by combining the set of generic nodes as described in conjunction with FIGS. 10B-10E and combining the set of complex nodes as described in conjunction with FIGS. 10F and 10G.

It will be apparent to a person skilled in the art that creation of complex nodes may be performed based on various combinations of complex nodes and generic nodes without deviating from the scope of the disclosure.

Although FIGS. 10A-10G describe creation of complex nodes based on generic nodes, run-time complex nodes may be created based on run-time nodes in a similar manner. Such a run-time complex node may be created by generating a node template by performing a first join operation on node templates of the run-time nodes and a node instance by performing a second join operation on nodes instances of the run-time nodes.

Having described the creation of the complex nodes by way of the join complex node behavior 606, the description now moves towards the creation of the complex nodes by way of the merge complex node behavior 608.

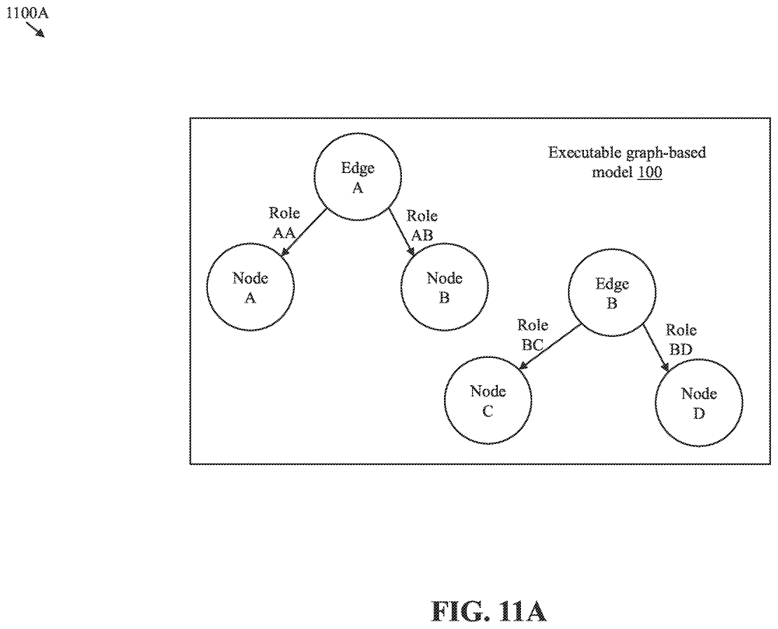

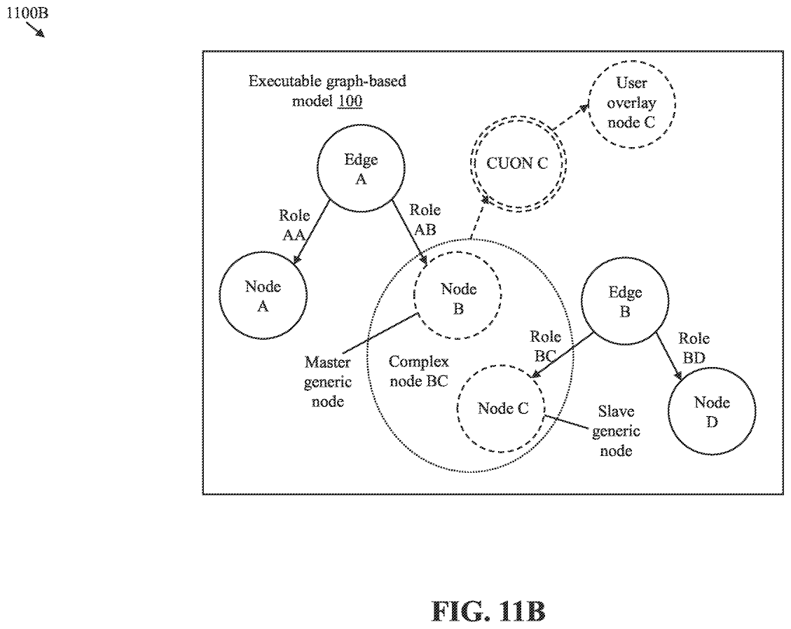

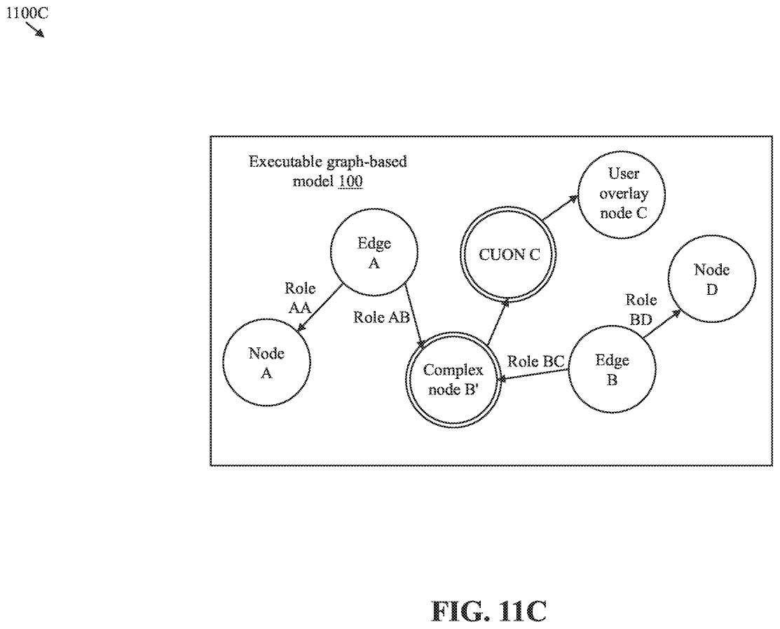

FIGS. 11A-11C are schematic diagrams 1100A-1100C that illustrate creation of the complex nodes based on the merge complex node behavior 608, in accordance with an embodiment of the present disclosure.

Referring to FIG. 11A, shown is a schematic diagram 1100A that has a description that is similar to the description of FIG. 10A. The processing circuitry (such as, the controller module 206) may receive a sixth stimulus (for example, the stimulus 230) associated with the overlay system 202. The sixth stimulus is indicative of creation of a complex node (namely, a primary complex node) based on the nodes B and C (e.g., the set of nodes). The sixth stimulus may be further indicative of the creation of the complex node by way of the merge complex node behavior 608. The processing circuitry (such as the controller module 206, the context module 210, and the stimuli management module 212) may be configured to match a context of the sixth stimulus with the set of defined contexts.

Referring now to FIG. 11B, illustrated is a schematic diagram 1100B. As shown, the nodes B and C are shown as dashed circles which indicates that the nodes B and C are identified by the processing circuitry (such as the controller module 206, the context module 210, the stimuli management module 212, and the complex usage management module 242) based on a context of the sixth stimulus being a match to the complex node creation context. In addition, based on the sixth stimulus, the node B may be selected as a master node (namely, a master generic node) and node C may be selected as a slave node (namely, a slave generic node). Additionally, the processing circuitry (such as the overlay management module 216 and the complex usage management module 242) is configured to instantiate a complex usage overlay node C. The complex usage overlay node C is linked to the complex node BC such that the complex usage overlay node C is an overlay of the complex node BC. The complex usage overlay node C has a description that is similar to the complex usage overlay node A. Subsequently, a merge operation is executed on the nodes B and C such that the node C (the slave generic node) is merged into the node B (the master generic node). Therefore, a new node that is a merged node created by merging the node C to a node B.

Referring now to FIG. 11C, illustrated is the schematic diagram 1100C. The merged node is depicted as a complex node B′. Subsequently, as shown, the processing circuitry (such as the complex usage management module 242) may associate the generic roles AB and BC with the complex node B′. The complex node B′ corresponds to a merged node that is created by merging the node C to the node B. Since, the merge operation leads to creation of a new node and the nodes B and C cease to exist, creation of new roles (complex roles) is not required. Pre-existing roles, i.e., the generic roles AB and BC that are implemented in the executable graph-based model 100 are associated with the complex node B′.

A history record of the complex node B′ is not maintained by the complex usage management module 242. Therefore, the complex node B′ may not be unmerged to re-create the nodes B and C.

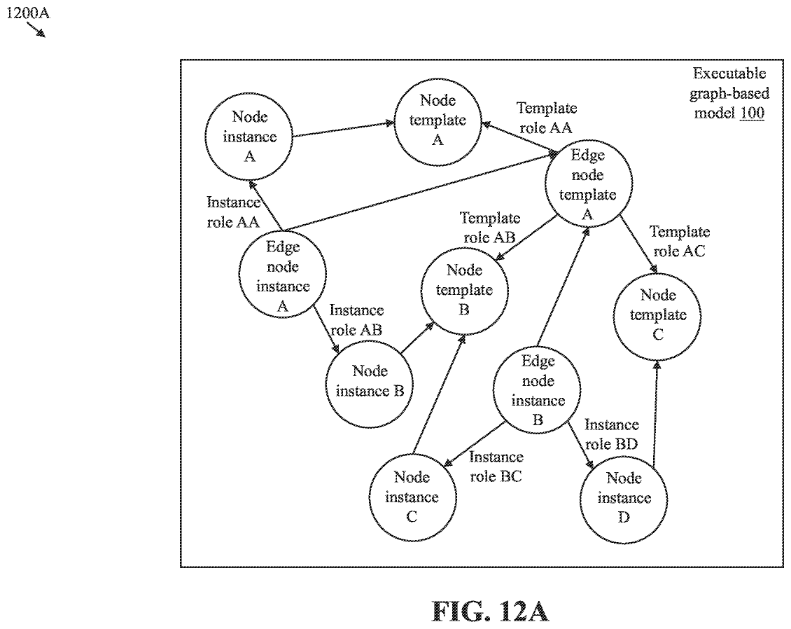

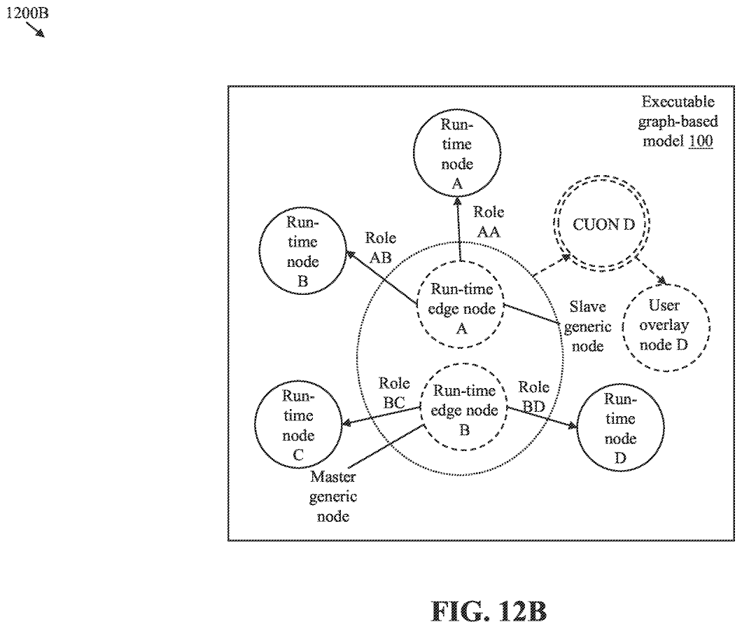

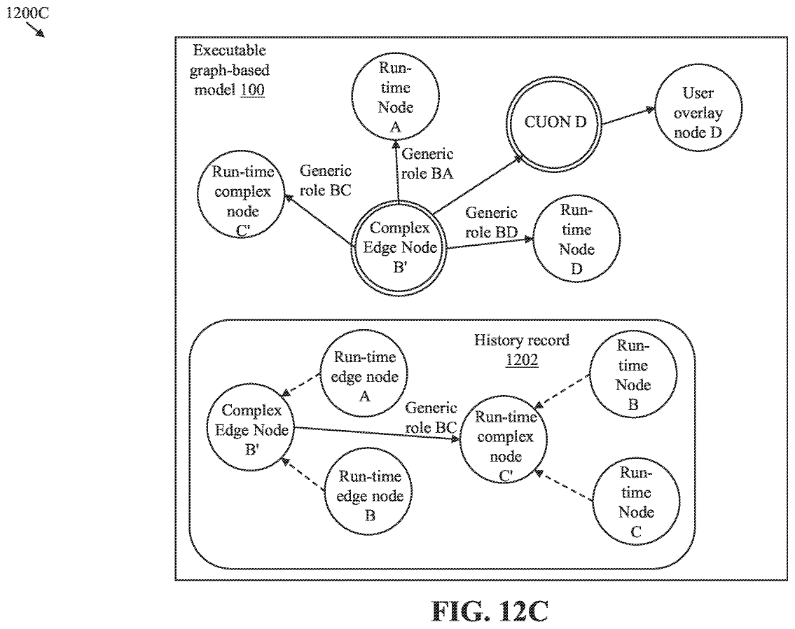

FIGS. 11A-11C illustrate creation of a complex node (for example, the complex node B′) based on a set of nodes that includes only base nodes (for example, the nodes B and C). Creation of the complex node based on the set of nodes that include run-time nodes is described in conjunction with FIGS. 12A-12C.

FIGS. 12A-12C are schematic diagrams 1200A-1200C that illustrate the creation of the complex nodes based on the merge complex node behavior 608, in accordance with another embodiment of the present disclosure.

Referring to FIG. 12A, illustrated is the schematic diagram 1200A that illustrates the executable graph-based model 100. As shown, the executable graph-based model 100 includes node templates A, B, and C and an edge node template A. Further, as shown, the node template A has a node instance A. The node template B has node instances B and C. The node template C has a node instance D. The edge node template A has edge nodes instances A and B. The edge node template A is associated with the node templates A, B, and C by way of template roles AA, AB, and AC, respectively. The edge node instance A is associated with the node instances A and B by way of instance roles AA and AB, respectively. The edge node instance B is associated with the node instances C and D by way of instance roles BC and BD, respectively.

Referring now to FIG. 12B, illustrated is a schematic diagram 1200B. FIG. 12B show the run-time nodes for the node templates and node instances shown in FIG. 12A. As shown, a run-time node A includes the node template A and the node instance A, a run-time node B includes the node template B and the node instance B, a run-time node C includes the node template C and the node instance C, a run-time node D includes the node template D and the node instance D, a run-time edge node A includes the edge node template A and the edge node instance A, and a run-time edge node B that includes the edge node template B and the edge node instance B. The run-time edge node A is coupled to the run-time nodes A and B via roles (namely, generic roles) AA and AB, respectively. The run-time edge node B is coupled to the run-time nodes C and D via roles (namely, generic roles) BC and BD, respectively. The processing circuitry may receive a seventh stimulus that is indicative of creation of a complex node based on the run-time edge nodes A and B. The seventh stimulus may be further indicative of the creation of the complex node by way of the merge complex node behavior 608. The processing circuitry (such as the controller module 206, the context module 210, and the stimuli management module 212) may be configured to match a context of the seventh stimulus with the set of defined contexts. Subsequently, based on the context being a match to the complex node creation context, the processing circuitry (such as the controller module 206, the context module 210, the stimuli management module 212, and the complex usage management module 242) may be configured to identify the run-time edge nodes A and B in the executable graph-based model 100.

As shown, the run-time edge nodes A and B are depicted by way of dashed circles which indicates that the run-time edge nodes A and B are identified and selected based on a user input that is received as the seventh stimulus. Based on a confirmation received via the API or the user device associated with the overlay system 202, the processing circuitry (such as the complex usage management module 242) may be configured to determine node-types of each node of the set of nodes, i.e., run-time edge nodes A and B. The processing circuitry (such as the complex usage management module 242) may determine that each of the run-time nodes A and B have an edge node-type and hence are run-time edge nodes. The processing circuitry (such as the complex usage management module 242) may further determine that the run-time edge nodes A and B are generic nodes. The processing circuitry (such as the complex usage management module 242) may also determine that the complex node may be created by way of the merge complex node behavior 608. In addition, the processing circuitry (such as the complex usage management module 242) may identify, based on the seventh stimulus, the run-time edge node A as the slave generic node and the run-time edge node B as the master generic node. Subsequently, the processing circuitry (such as the complex usage management module 242) may execute a set of operations, associated with the merge complex node behavior 608, on the run-time edge nodes A and B to create a complex edge node B′ (shown in FIG. 12C).

Referring now to FIG. 12C, for executing the set of operations, the processing circuitry (such as the complex usage management module 242) is configured to execute a set of operations on the run-time edge nodes A and B to create a combined node that is a combination of the run-time edge nodes A and B. The set of operations is associated with the complex node behavior by way of which the complex node is to be created. That is to say that, the processing circuitry (such as the complex usage management module 242) is configured to execute a merge operation on the run-time edge nodes A and B to create a merged node. The combined node pertains to the merged node when the complex node behavior corresponds to the merge complex node behavior 608. The merged node is a result of the merge operation executed on the run-time edge nodes A and B. Subsequently, the processing circuitry (such as the complex usage management module 242) is configured to identify, from the run-time edge nodes A and B, one or more nodes that are associated with other nodes in the executable graph-based model 100. As shown, the run-time edge node A is associated with the run-time nodes A and B. The run-time edge node A is coupled to the run-time nodes A and B by way of the generic roles AA and AB, respectively. The run-time edge node B is coupled to the run-time nodes C and D by way of the generic roles AC and AD, respectively. The generic roles (for example, the generic roles AA and AB) associated with the run-time edge node A (the slave generic node) are transferred to the run-time edge node B (the master generic node). The complex edge node B′ is thus created. The complex edge node B′ is extended by way of a complex usage overlay node D that is further extended by way of a user overlay node D. Similarly, a complex node C′ may be created, based on an eighth stimulus, by merging the node B (a slave generic node) into the node C (a master generic node).

As shown, a history record 1202 may be maintained by the processing circuitry (such as the complex usage management module 242) in the executable graph-based model 100. The history record 1202 includes a node record that the complex edge node B′ is the merged node that includes the run-time edge nodes A and B. The history record 1202 includes another node record that the run-time complex node C′ is the merged node that includes the run-time nodes B and C. The history record 1202 further depicts that the run-time complex node B′ and C′ are associated by way of the generic role BC. The history record 1202 may be used by the processing circuitry (such as the complex usage management module 242) to rollback the complex node creation to unmerge the complex edge node B′ and/or the run-time complex node C′. For the sake of brevity, a complex usage overlay node associated with the run-time complex node C′ is not shown.

Although FIGS. 12A-12C describe the creation of the complex nodes based on the sets of nodes that include generic nodes. It will be apparent to a person skilled in the art that the complex nodes may be created based on the sets of nodes, including secondary complex nodes, in a similar manner.

For the sake of brevity, roles (for example, generic roles and complex roles) associated with each node are depicted in corresponding drawings as arrows. In practical implementation, each role may be realized in the form of a role node as described in conjunction with FIGS. 3A and 3B.

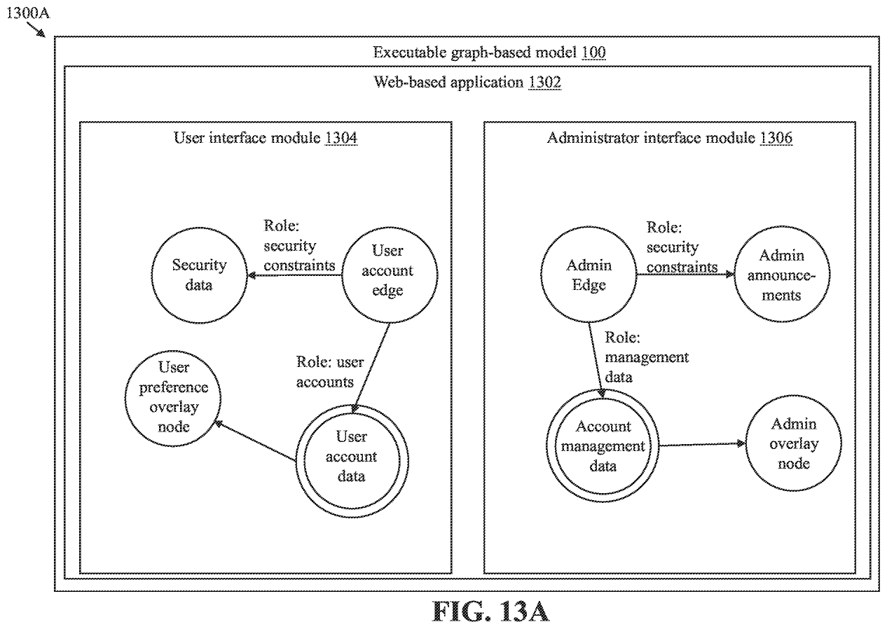

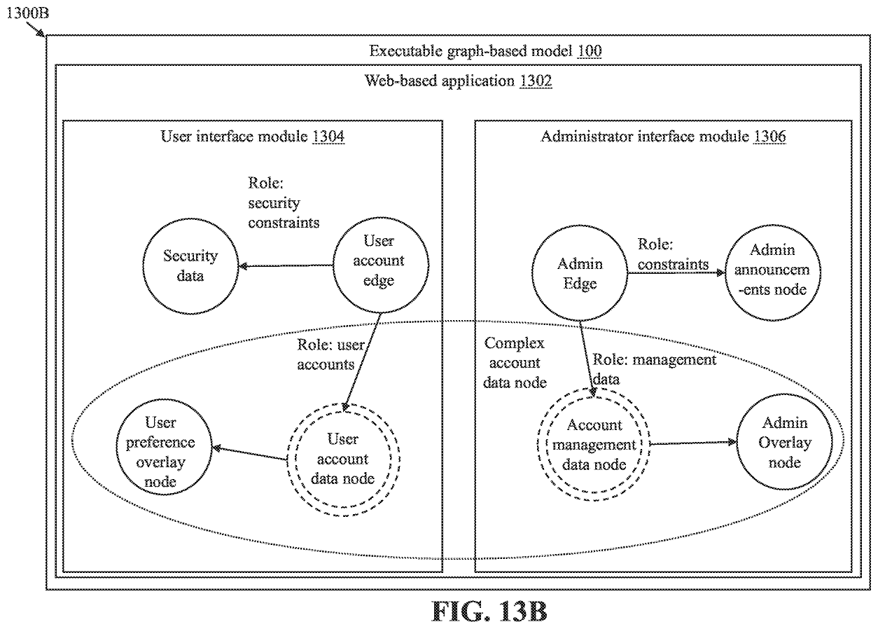

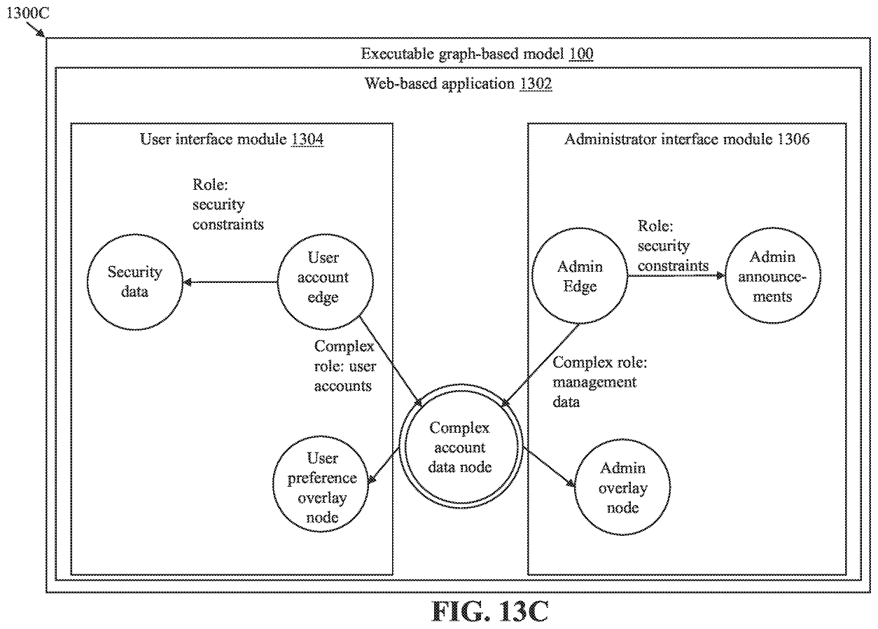

FIGS. 12A-12C describe different concepts associated with the creation and maintenance of the complex nodes in the executable graph-based model 100. Such concepts have diverse application areas one of which is described in conjunction with FIGS. 13A-13C.

FIGS. 13A-13C are schematic diagrams 1300A-1300C that illustrate an example implementation of the overlay system 202, in accordance with an embodiment of the present disclosure. Referring to FIG. 13A, shown is the schematic diagram 1300A that depicts the executable graph-based model 100. The executable graph-based model 100 is used to implement a web-based application 1302. The web-based application 1302 refers to a software product that provides a software as a service (for example, a banking service, a fintech service, a gaming platform, or the like) to its users. The web-based application 1302 includes a user interface module 1304 and an administrator interface module 1306 that are implemented by way of nodes of the executable graph-based model 100. The user interface module 1304 provides a user interaction platform by way of which users may interact with the web-based application 1302. The administrator interface module 1306 provides a backend interface to administrators of the web-based application 1302. The backend interface may be used to manage the web-based application 1302.

As shown, the user interface module 1304 includes nodes ‘Security data’ and ‘User account data’. The node ‘User account data’ may store data associated with the users of the web-based application 1302. The node ‘Security data’ may store data associated with security techniques to be applied for securing/protecting the data stored at the node ‘User account data’. Further, the nodes ‘Security data’ and ‘User account data’ are coupled by way of an edge ‘User account edge’. The node ‘Security data’ is associated with the ‘User account edge’ by way of a role node ‘security constraints’ (represented by way of an arrow connecting the node ‘Security data’ with the ‘User account edge’). The node ‘User account data’ is associated with the ‘User account edge’ by way of a role node ‘user accounts’ (represented by way of an arrow connecting the node ‘User account data’ with the ‘User account edge’). Further, the node ‘User account data’ is associated with a ‘User preference Overlay node’ that stores user preferences, of users of the web-based application 1302, associated with acquisition and storage of data associated with the users, and processing logic to implement the user preferences.

The administrator interface module 1306 includes nodes ‘Admin announcements’ and ‘Account management data’. The node ‘account management data’ may store data associated with management (creation, deletion, actions, or the like) of the user accounts linked with the web-based application 1302. The node ‘Admin announcements’ may store data associated with notifications/announcements generated by the administrators of the web-based application 1302, where the notifications/announcements may be regarding the management of the user accounts. Further, the nodes ‘Admin announcements’ and ‘Account management data’ are coupled by way of an edge ‘Admin edge’. The node ‘Admin announcements’ is associated with the ‘Admin edge’ by way of a role node ‘constraints’ (represented by way of an arrow connecting the node Admin announcements’ with the ‘Admin edge’). The node ‘Account management data’ is associated with the ‘Admin edge’ by way of a role node ‘management data’ (represented by way of an arrow connecting the node ‘Account management data’ with the ‘Admin edge’). Further, the node ‘Account management data’ is associated with an ‘Admin overlay node’ that stores processing logic to execute one or more operations associated with the maintenance of the user accounts.

In some instances, the users of the web-based application 1302 may require to access the data stored in the node ‘Account management data’ and an administrator may require to access user data stored in the node ‘User account data’ to take one or more administrative decisions. Therefore, a complex node is created by way of the join complex node behavior 606 as the nodes ‘Account management data’ and ‘User account data’ have different types of data, and hence, original structures of the nodes ‘Account management data’ and ‘User account data’ are to be persisted.

Referring now to FIG. 13B, based on a ninth stimulus (e.g., the stimulus 230), the nodes ‘Account management data’ and ‘User account data’ may be selected for creation of a complex node. The selection of the nodes ‘Account management data’ and ‘User account data’ is presented by depiction thereof by way of dashed circles. The ninth stimulus may indicate that the complex node (a complex account data node shown by way of a dotted oval) is to be created by way of the join complex node behavior 606. Since the nodes ‘Account management data’ and ‘User account data’ are associated with the ‘Admin overlay node’ and ‘user preference overlay node’, respectively, the complex node is created further based on the ‘Admin overlay node’ and the ‘User preference overlay node’ that are overlays of the nodes ‘Account management data’ and ‘User account data’, respectively.

Referring now to FIG. 13C, a ‘Complex account data node’ is created by way of the join complex node behavior 606 such that the join operation is executed on the nodes ‘Account management data’ and the ‘User account data’. In addition, the ‘Admin overlay node’ and the ‘User preference overlay node’ are overlay nodes with different overlay node-type and include different processing logics. Therefore, the ‘Admin overlay node’ and the ‘User preference overlay node’ are associated with the ‘Complex account data node’ as overlays thereof. In instances, when the ‘Admin overlay node’ and the ‘User preference overlay node’ may have the same overlay node-type, the ‘Admin overlay node’ and the ‘User preference overlay node’ may be combined to create a complex overlay node by way of the processing complex node behavior 610.

In some instances, the ‘Complex account data node’ may inherit a generic node or a complex node that may be inherited by at least one of the nodes ‘Account management data’ and ‘User account data’. In some instances, when each of the nodes ‘Account management data’ and ‘User account data’ may inherit a corresponding node, another complex node may be created by combining the nodes inherited by the nodes ‘Account management data’ and ‘User account data’. The another complex node may be inherited by the ‘Complex account data node’.

In some instances, the users of the web-based application 1302 may be allowed to access only a corresponding specific portion of the data stored at the node ‘Account management data’. In such instances, the complex account data node may be associated with a set of permissions that allows each user to use only the corresponding specific portion of the data stored at the node ‘Account management data’.

Based on such creation of the ‘Complex account data node’, users as well as administrators of the web-based application 1302 may easily access user data as well as account management data by accessing only a single node. Notably, retrieval of data from its corresponding node and/or storage location takes place in the background and remains hidden from the user/administrator. Therefore, such creation of the ‘Complex account data node’ allows the implementation of the web-based application 1302 to be simpler and easy to use.

For the sake of brevity, a complex usage overlay node associated with the ‘Complex account data node’ is not depicted in FIG. 13C. It will be apparent to a person skilled in the art that in practical implementations, the ‘Complex account data node’ may be associated with a corresponding complex usage overlay node.

For the sake of brevity, creation of only a single complex node is described herein. In practical implementations, multiple complex nodes may be created by way of different complex node behaviors. It will be apparent to a person skilled in the art that based on the creation of the complex nodes in the executable graph-based model 100, advanced overlay nodes, that include processing logic to be executed on the complex nodes, may be created. Such advanced overlay nodes may include processing logic that is complex and simplifies execution of corresponding operations using the sets of nodes included in the complex nodes.

The present disclosure describes the creation of the complex nodes by executing the join operation and/or the merge operation. In some embodiments, the complex nodes may be creating based on execution of one or more other logical operations (for example, an intersection operation). In an example, a complex node may be created by performing an intersection operation on a first node and a second node. The complex node may include a plurality of attribute values of a plurality of attributes that are common to the first and second nodes.

Having described systems for the creation and maintenance of the complex nodes, the description now discusses methods for the creation and maintenance of the complex nodes.

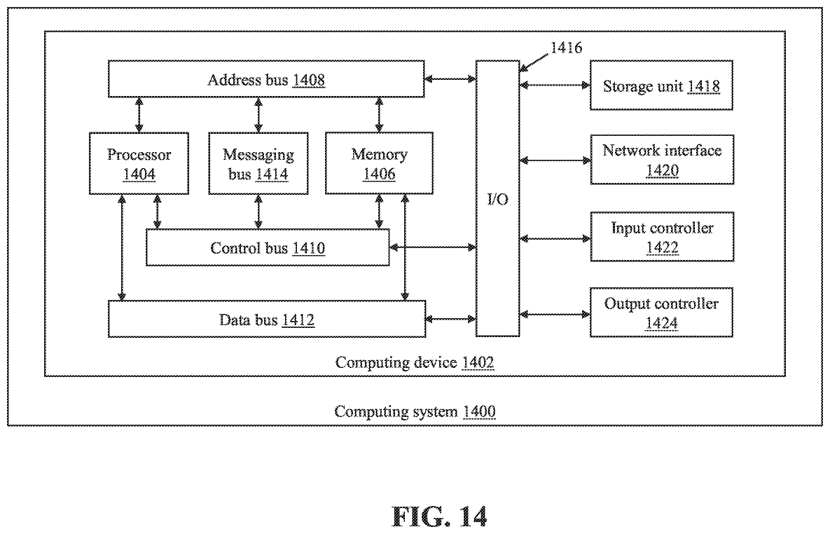

FIG. 14 shows an example computing system 1400 for carrying out the methods of the present disclosure, in accordance with an embodiment of the present disclosure. Specifically, FIG. 14 shows a block diagram of an embodiment of the computing system 1400 according to example embodiments of the present disclosure.

The computing system 1400 may be configured to perform any of the operations disclosed herein, such as for example, any of the operations discussed with reference to the functional modules described in relation to FIG. 2. The computing system 1400 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1400 is a distributed system configured to function using multiple computing machines interconnected via a data network or bus system.

The computing system 1400 includes computing devices (such as a computing device 1402). The computing device 1402 includes one or more processors (such as a processor 1404) and a memory 1406. The processor 1404 may be any general-purpose processor(s) configured to execute a set of instructions. For example, the processor 1404 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1404 may be multiple processing units, a single processing core, multiple processing cores, special purpose processing cores, co-processors, or any combination thereof. The processor 1404 may be communicatively coupled to the memory 1406 via an address bus 1408, a control bus 1410, a data bus 1412, and a messaging bus 1414.

The memory 1406 may include non-volatile memories such as a read-only memory (ROM), a programable read-only memory (PROM), an erasable programmable read-only memory (EPROM), a flash memory, or any other device capable of storing program instructions or data with or without applied power. The memory 1406 may also include volatile memories, such as a random-access memory (RAM), a static random-access memory (SRAM), a dynamic random-access memory (DRAM), and a synchronous dynamic random-access memory (SDRAM). The memory 1406 may include single or multiple memory modules. While the memory 1406 is depicted as part of the computing device 1402, a person skilled in the art will recognize that the memory 1406 can be separate from the computing device 1402.

The memory 1406 may store information that can be accessed by the processor 1404. For instance, the memory 1406 (e.g., one or more non-transitory computer-readable storage mediums, memory devices) may include computer-readable instructions (not shown) that can be executed by the processor 1404. The computer-readable instructions may be software written in any suitable programming language or may be implemented in hardware. Additionally, or alternatively, the computer-readable instructions may be executed in logically and/or virtually separate threads on the processor 1404. For example, the memory 1406 may store instructions (not shown) that when executed by the processor 1404 cause the processor 1404 to perform operations such as any of the operations and functions for which the computing system 1400 is configured, as described herein. Additionally, or alternatively, the memory 1406 may store data (not shown) that can be obtained, received, accessed, written, manipulated, created, and/or stored. The data can include, for instance, the data and/or information described herein in relation to FIGS. 1-13C. In some implementations, the computing device 1402 may obtain from and/or store data in one or more memory device(s) that are remote from the computing system 1400.

The computing device 1402 may further include an input/output (I/O) interface 1416 communicatively coupled to the address bus 1408, the control bus 1410, and the data bus 1412. The data bus 1412 and messaging bus 1414 may include a plurality of tunnels that may support parallel execution of messages by the overlay system 202. The I/O interface 1416 is configured to couple to one or more external devices (e.g., to receive and send data from/to one or more external devices). Such external devices, along with the various internal devices, may also be known as peripheral devices. The I/O interface 1416 may include both electrical and physical connections for operably coupling the various peripheral devices to the computing device 1402. The I/O interface 1416 may be configured to communicate data, addresses, and control signals between the peripheral devices and the computing device 1402. The I/O interface 1416 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 1416 is configured to implement only one interface or bus technology. Alternatively, the I/O interface 1416 is configured to implement multiple interfaces or bus technologies. The I/O interface 1416 may include one or more buffers for buffering transmissions between one or more external devices, internal devices, the computing device 1402, or the processor 1404. The I/O interface 1416 may couple the computing device 1402 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1416 may couple the computing device 1402 to various output devices, including video displays, speakers, printers, projectors, tactile feedback devices, automation control, robotic components, actuators, motors, fans, solenoids, valves, pumps, transmitters, signal emitters, lights, and so forth.

The computing system 1400 may further include a storage unit 1418, a network interface 1420, an input controller 1422, and an output controller 1424. The storage unit 1418, the network interface 1420, the input controller 1422, and the output controller 1424 are communicatively coupled to the central control unit (e.g., the memory 1406, the address bus 1408, the control bus 1410, and the data bus 1412) via the I/O interface 1416. The network interface 1420 communicatively couples the computing system 1400 to one or more networks such as wide area networks (WAN), local area networks (LAN), intranets, the Internet, wireless access networks, wired networks, mobile networks, telephone networks, optical networks, or combinations thereof. The network interface 1420 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1418 is a computer-readable medium, preferably a non-transitory computer-readable medium, comprising one or more programs, the one or more programs comprising instructions which when executed by the processor 1404 cause the computing system 1400 to perform the method steps of the present disclosure. Alternatively, the storage unit 1418 is a transitory computer-readable medium. The storage unit 1418 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1418 stores one or more operating systems, application programs, program modules, data, or any other information. The storage unit 1418 is part of the computing device 1402. Alternatively, the storage unit 1418 is part of one or more other computing machines that are in communication with the computing device 1402, such as servers, database servers, cloud storage, network attached storage, and so forth.

The input controller 1422 may include suitable logic, circuitry, interfaces, and/or code, executable by the circuitry, that may be configured to control one or more input devices that may be configured to receive an input (the stimulus 230) for the overlay system 202. The output controller 1424 may include suitable logic, circuitry, interfaces, and/or code, executable by the circuitry, that may be configured to control one or more output devices that may be configured to render/output the outcome of the operation executed to process the received input (the stimulus 230).

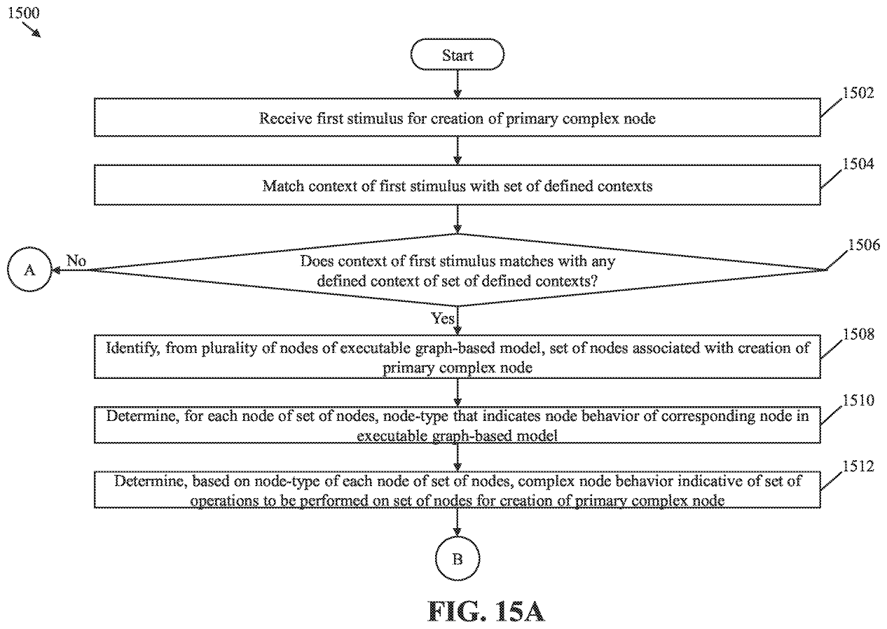

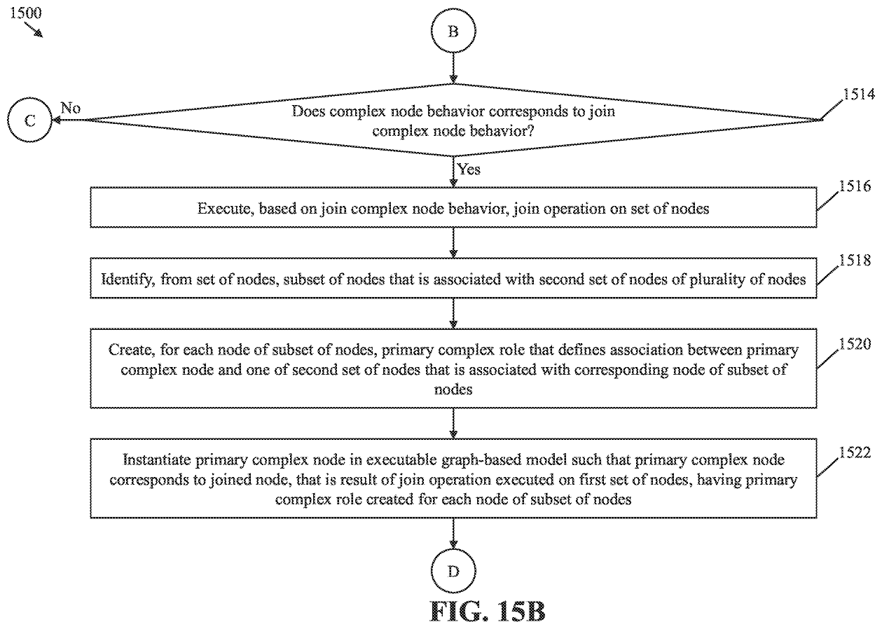

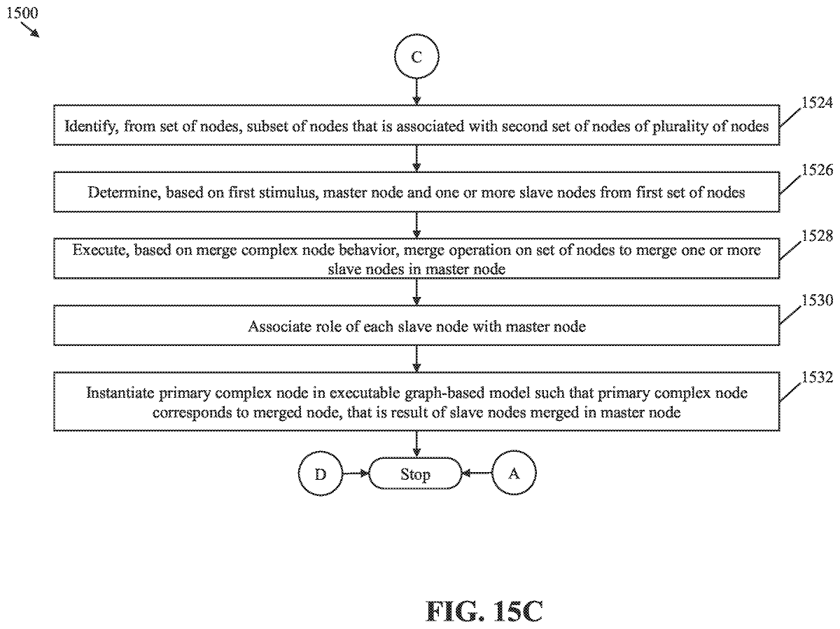

FIGS. 15A-15C, collectively, illustrate a flowchart 1500 of a method for creation of a complex node (for example, the complex node 602), in accordance with an embodiment of the present disclosure.

Referring to FIG. 15A, at 1502, a first stimulus is received. The processing circuitry (such as the controller module 206 and the stimuli management module 212) receives the first stimulus associated with the overlay system 202. The first stimulus is indicative of the creation of the complex node (namely, the primary complex node) in the executable graph-based model 100. At 1504, the context of the first stimulus is matched with the set of defined contexts. The processing circuitry (such as the controller module 206 and the stimuli management module 212) may match the context of the first stimulus with the set of defined contexts. At 1506, it is determined that whether a context of the first stimulus matches with any defined context of the set of defined contexts. The processing circuitry (such as the context module 210) may determine that whether the context of the first stimulus matches with any defined context of the set of defined contexts. In an instance, when it is determined that the context of the first stimulus does not match with any of the set of defined contexts, the method terminates. In another instance, when it is determined that the context of the first stimulus matches with the node creation context of the set of defined contexts, 1508 is executed.

At 1508, the set of nodes associated with the creation of the complex node is identified from the plurality of nodes of the executable graph-based model 100. The processing circuitry (such as the controller module 206, the context module 210, and the stimuli management module 212) may identify the set of nodes associated with the creation of the complex node. At 1510, the node-type of each node of the set of nodes is determined. The node-type of each node indicates node behavior of the corresponding node in the executable graph-based model 100. The processing circuitry (such as the controller module 206, the context module 210, and the stimuli management module 212) may determine the node-type of each node of the set of nodes. At 1512, the complex node behavior, that is indicative of the set of operations to be performed on the set of nodes for the creation of the complex node, is determined. The processing circuitry (such as the complex usage management module 242) determines the complex node behavior that is indicative of the set of operations to be performed on the set of nodes for the creation of the complex node.

Referring now to FIG. 15B, at 1514, it is determined whether the complex node behavior corresponds to the join complex node behavior 606. In an instance, when the complex node behavior corresponds to the join complex node behavior 606, 1516 is executed. At 1516, based on the join complex node behavior 606, the join operation is executed on the set of nodes. The processing circuitry (such as the complex usage management module 242) may execute, based on the join complex node behavior 606, the join operation on the set of nodes. At 1518, a subset of nodes, that is associated with a second set of nodes of the executable graph-based model 100, is identified from the set of nodes. The second set of nodes are nodes of the executable graph-based model 100 that are different from the set of nodes based on which the complex node is to be created. The processing circuitry (such as the complex usage management module 242) identifies the subset of nodes from the set of nodes. At 1520, for each node of the subset of nodes, the primary complex role is created for each generic role associated therewith. The primary complex role defines the association between the complex node and one of second set of nodes that is associated with corresponding node of subset of nodes. The processing circuitry (such as the complex usage management module 242) may create the primary complex role for each node of the subset of nodes. At 1522, the complex node is instantiated in the executable graph-based model 100 such that the complex node corresponds to the joined node that is a result of the join operation executed on the set of nodes. The joined node is associated with the primary complex roles created for each node of the subset of nodes.

At 1514, when it is determined that the complex node behavior does not correspond to the join complex node behavior 606, 1524 is executed. Referring now to FIG. 15C, at 1524, the subset of nodes, that is associated with the second set of nodes of the executable graph-based model 100, is identified from the set of nodes. The second set of nodes are nodes of the executable graph-based model 100 that are different from the set of nodes based on which the complex node is to be created. The processing circuitry (such as the complex usage management module 242) identifies the subset of nodes from the set of nodes. At 1526, based on the first stimulus, the master node and the one or more slave nodes are determined from the set of nodes. The processing circuitry (such as the complex usage management module 242) determines the master node and the one or more slave nodes from the set of nodes. At 1528, the merge operation is executed on the set of nodes based on the merge complex node behavior 608. The processing circuitry (such as the complex usage management module 242) executes the merge operation on the set of nodes based on the merge complex node behavior 608. At 1530, the role (namely, generic role) of each slave node is associated with the master node. The processing circuitry (such as the complex usage management module 242) associates the role of each slave node with the master node. At 1532, the complex node is instantiated in the executable graph-based model 100 such that the complex node corresponds to the merged node that is the result of the slave nodes merged into the master node. Thus, the creation of the complex node is executed.

The disclosed embodiments encompass numerous advantages including a simple and user-friendly implementation of the executable-graph based model 100 that may be in turn used to implement various complex and advanced applications. Further, the disclosed systems and methods allow for creation of the complex nodes based on the nodes of the executable graph-based model 100 such that no prior knowledge of schema/ontology and data associated with the executable graph-based model 100 is required. Moreover, the systems and methods disclosed herein allows to group the set of nodes such that a single instantiation and connection with an overlay node is sufficient for executing processing logic associated therewith on each node of the set of nodes. In addition, the set of nodes may be associated with an operation, therefore only the complex node is required to be loaded, by way of a single transaction, for execution of the operation which makes the loading and referring to the nodes easier. Hence, the execution of the operation is also efficient as the time complexity and cost complexity associated therewith is optimized. The systems and methods disclosed herein allows for implementation of complex and advanced applications by way of the executable graph-based model 100 such that the implementation is simple to understand and easy to use as complex structures, functionalities, and behaviors are handled at backend by way of the complex nodes. Application areas of the systems and methods disclosed herein are fintech platforms, social media platforms, gaming platforms, research and analytics platforms, robotics, or the like.

Certain embodiments of the disclosure may be found in the disclosed systems, methods, and non-transitory computer-readable medium, for facilitating creation and maintenance of complex nodes in the executable graph-based models. The methods and systems disclosed herein include various operations performed by the processing circuitry (e.g., the controller module 206, the transaction module, 208, the message management module 214, and the complex usage management module 242, any other element of the overlay system 202, or a combination of two or more elements of the overlay system 202). The systems disclosed herein includes a storage element that is configured to store an executable graph-based model that includes a plurality of nodes. The processing circuitry is coupled to the storage element and is configured to receive a first stimulus associated with the overlay system. The first stimulus is indicative of creation of a first primary complex node in the executable graph-based model. The processing circuitry is further configured to identify, from the plurality of nodes, based on the first stimulus, a first set of nodes associated with the creation of the first primary complex node. The processing circuitry is further configured to determine, for each node of the first set of nodes, a node-type that indicates a node behavior of the corresponding node in the executable graph-based model. The processing circuitry is further configured to determine, based on the node-type of each node of the first set of nodes, a complex node behavior that is indicative of a first set of operations to be performed for the creation of the first primary complex node. The processing circuitry is further configured to execute the first set of operations on the first set of nodes to create the first primary complex node.

In some embodiments, the node-type of each node of the first set of nodes is one of a group consisting of a vertex node-type, an edge node-type, and an overlay node-type.

In some embodiments, the node behavior, of each node of the first set of nodes, corresponds to one of a group consisting of a vertex node behavior, an edge node behavior, and an overlay node behavior. Each node with the vertex node behavior is configured to store data associated with the overlay system. Each node with the edge node behavior is configured to couple two or more nodes, of the plurality of nodes, with the vertex node behavior. Each node with the overlay node behavior is configured to execute a processing logic on a node associated therewith.

In some embodiments, the complex node behavior is one of a group consisting of a join complex node behavior and a merge complex node behavior. The join complex node behavior is indicative of the first set of operations including a join operation that is executed on the first set of nodes when one of a group consisting of: (i) one or more nodes of the first set of nodes have a node-type that is different from a node-type of remaining nodes of the first set of nodes and (ii) each node of the first set of nodes has an identical node-type. The merge complex node behavior is indicative of the first set of operations including a merge operation that is executed on the first set of nodes when each node of the first set of nodes has the identical node-type.

In some embodiments, the node-type of each node of the plurality of nodes is one of a group consisting of an edge node-type, a vertex node-type, and an overlay node-type. The first primary complex node is a complex edge node when the node-type of at least one node of the first set of nodes is the edge node-type. The first primary complex node is a complex vertex node when the node-type of each node of the first set of nodes is the vertex node-type. The first primary complex node is the complex overlay node when the node-type of each node of the first set of nodes is an overlay node-type.

In some embodiments, the processing circuitry is further configured to identify, from the first set of nodes a subset of nodes that is associated with a second set of nodes of the plurality of nodes. The second set of nodes is different from the first set of nodes. Each node of the subset of nodes has a corresponding role that defines an association with at least one of the second set of nodes. The processing circuitry is further configured to create a combined node, based on the execution of the first set of operations on the first set of nodes. The combined node is a combination of the first set of nodes. The processing circuitry is further configured to associate, with the combined node, at least one role for each node of the subset of nodes. The associated role represents an association with at least one node of the second set of nodes that is associated with the corresponding node of the subset of nodes. The processing circuitry is further configured to instantiate the first primary complex node in the executable graph-based model such that the first primary complex node corresponds to the combined node with the role for each node of the subset of nodes associated therewith.

In some embodiments, the processing circuitry is further configured to receive a second stimulus associated with the overlay system. The second stimulus is indicative of an operation to be executed using one or more nodes of the first set of nodes in the first primary complex node. The processing circuitry is further configured to identify, based on the second stimulus, the first primary complex node in the executable graph-based model. The processing circuitry is further configured to determine one or more roles associated with the first primary complex node that conforms with the second stimulus. The determined one or more roles are associated with the one or more nodes. The processing circuitry is further configured to communicate the second stimulus to the first primary complex node based on the determined one or more roles. The processing circuitry is further configured to execute the operation associated with the second stimulus using the first primary complex node that includes the one or more nodes using which the operation associated with the second stimulus is to be executed.

In some embodiments, to execute the first set of operations, the processing circuitry is further configured to execute, based on the complex node behavior, a join operation on the first set of nodes. The processing circuitry is further configured to identify, from the first set of nodes, a set of generic nodes that is associated with a second set of nodes of the plurality of nodes. The second set of nodes is different from the first set of nodes. Each node of the set of generic nodes has a generic role that defines an association with at least one of the second set of nodes. The processing circuitry is further configured to create, for each generic node of the set of generic nodes, a primary complex role that defines an association between the first primary complex node and one of the second set of nodes that is associated with the corresponding generic node of the set of generic nodes. The primary complex role is mapped to the corresponding generic node of the set of generic nodes by way of the generic role. The processing circuitry is further configured to instantiate the first primary complex node in the executable graph-based model such that the first primary complex node corresponds to a joined node, that is a result of the join operation executed on the first set of nodes, having the primary complex role created for each node of the set of generic nodes.

In some embodiments, the processing circuitry is further configured to receive a second stimulus associated with the overlay system. The second stimulus is indicative of an operation to be executed using one or more generic nodes of the set of generic nodes in the first primary complex node. The processing circuitry is further configured to identify, based on the second stimulus, the first primary complex node in the executable graph-based model. The processing circuitry is further configured to determine one or more primary complex roles associated with the first primary complex node that conform with the second stimulus. The processing circuitry is further configured to map each of the one or more primary complex roles to a corresponding generic role. The processing circuitry is further configured to identify, based on the mapping between each of the one or more primary complex roles and the corresponding generic role, the one or more generic nodes from the set of generic nodes in the first primary complex node using which the operation is to be executed. The processing circuitry is further configured to redirect the second stimulus to the one or more generic nodes of the set of generic nodes. The processing circuitry is further configured to execute the operation associated with the second stimulus using the one or more generic nodes.

In some embodiments, to execute the first set of operations, when each node of the first set of nodes corresponds to a secondary complex node, the processing circuitry is further configured to execute, based on the complex node behavior, a join operation on the first set of nodes. The processing circuitry is further configured to identify, from the first set of nodes, a set of secondary complex nodes that is associated with a second set of nodes of the plurality of nodes. The second set of nodes is different from the first set of nodes. Each secondary complex node of the set of secondary complex nodes has a secondary complex role that defines an association with at least one of the second set of nodes. The processing circuitry is further configured to create, for each of the set of secondary complex nodes, a primary complex role that defines an association between the first primary complex node and one of the second set of nodes that is associated with the corresponding secondary complex node of the set of secondary complex nodes. The primary complex role is mapped to the corresponding secondary complex node of the set of secondary complex nodes by way of the associated secondary complex role. The processing circuitry is further configured to instantiate the first primary complex node in the executable graph-based model such that the first primary complex node corresponds to a joined node, that is a result of the join operation executed on the first set of nodes, having the primary complex role created for each secondary complex node of the set of secondary complex nodes.

In some embodiments, the processing circuitry is further configured to receive a second stimulus associated with the overlay system. The second stimulus is indicative of an operation to be executed using the first primary complex node. The processing circuitry is further configured to determine one or more primary complex roles associated with the first primary complex node that conform with the second stimulus. The processing circuitry is further configured to map each of the one or more primary complex roles to a corresponding secondary complex role. The processing circuitry is further configured to identify, based on the mapping between each of the one or more primary complex roles and the corresponding secondary complex role, one or more secondary complex nodes from the set of secondary complex nodes using which the operation is to be executed. The processing circuitry is further configured to redirect the second stimulus to the identified one or more secondary complex nodes. Each identified secondary complex node has at least one secondary complex role. The processing circuitry is further configured to map the secondary complex role of each identified secondary complex node to a corresponding generic role associated with a set of generic nodes included in the corresponding secondary complex node. The processing circuitry is further configured to identify, based on the mapping between the secondary complex role of each identified secondary complex node and the corresponding generic role, the set of generic nodes on which the operation is to be executed. The processing circuitry is further configured to execute the operation associated with the second stimulus using the set of generic nodes of each identified secondary complex node.

In some embodiments, to execute the first set of operations when the first set of nodes includes a set of generic nodes and a set of secondary complex nodes, the processing circuitry is further configured to execute, based on the complex node behavior, a join operation on the set of generic nodes and the set of secondary complex nodes. The processing circuitry is further configured to identify, a set of generic nodes and a set of secondary complex nodes from the set of generic nodes and the set of secondary complex nodes, respectively. The set of generic nodes and the set of secondary complex nodes are associated with a second set of nodes, of the plurality of nodes, that is different from the first set of nodes. Each generic node of the set of generic nodes has a corresponding generic role that defines an association with at least one of the second set of nodes and each secondary complex node of the set of secondary complex nodes has a secondary complex role that defines an association with at least one of the second set of nodes. The processing circuitry is further configured to create, for each of the set of generic nodes and the set of secondary complex nodes, a primary complex role that defines an association between the first primary complex node and one of the second set of nodes associated with one of the corresponding generic node and the corresponding secondary complex node. The primary complex role created for each node of the set of generic nodes is mapped to the corresponding generic node by way of the associated generic role. The primary complex role created for each node of the set of secondary complex nodes is mapped to the corresponding secondary complex node by way of the associated secondary complex role. The processing circuitry is further configured to instantiate the first primary complex node in the executable graph-based model such that the first primary complex node corresponds to a joined node, that is a result of the join operation executed on the set of generic nodes and the set of secondary complex nodes, having the primary complex role created for each of the set of generic nodes and the set of secondary complex nodes.

In some embodiments, the processing circuitry is further configured to receive a second stimulus associated with the overlay system. The second stimulus is indicative of an operation to be executed on at least one of (i) one or more generic nodes of the set of generic nodes and (ii) one or more secondary complex nodes of the set of secondary complex nodes in the first primary complex node. The processing circuitry is further configured to determine one or more primary complex roles associated with the first primary complex node that conform with the second stimulus. The processing circuitry is further configured to map each of the one or more primary complex roles to one of a corresponding generic role and a corresponding secondary complex role. The processing circuitry is further configured to identify, based on the mapping between each of the one or more primary complex roles and one of the corresponding generic role and the corresponding secondary complex role, at least one of (i) the one or more generic nodes from the set of generic nodes and (ii) the one or more secondary complex nodes from the set of secondary complex nodes, using which the operation is to be executed. The processing circuitry is further configured to redirect the second stimulus to at least one of the one or more generic nodes and the one or more secondary complex nodes. Each identified generic node has at least one generic role and each identified secondary complex node has at least one secondary complex role. The processing circuitry is further configured to execute the operation associated with the second stimulus using at least one of the one or more generic nodes and the one or more secondary complex nodes.

In some embodiments, to execute the first set of operations, the processing circuitry is further configured to identify, from the first set of nodes, a set of generic nodes that is associated with a second set of nodes of the plurality of nodes. The second set of nodes is different from the first set of nodes, and each node of the set of generic nodes has a generic role that defines an association with at least one of the second set of nodes. The processing circuitry is further configured to determine, based on the first stimulus, a master generic node and one or more slave generic nodes from the first set of nodes. The processing circuitry is further configured to execute, based on the complex node behavior, a merge operation on the first set of nodes. During the execution, the one or more slave generic nodes are merged into the master generic node. The processing circuitry is further configured to associate the generic role, of the one or more slave generic nodes, with the master generic node. The processing circuitry is further configured to instantiate the first primary complex node in the executable graph-based model such that the first primary complex node corresponds to a merged node, that is a result of the merge operation executed to merge each slave generic node of the first set of nodes in the master generic node. The master generic node has the generic role of each slave generic node of the set of generic nodes.

In some embodiments, the processing circuitry is further configured to receive a second stimulus associated with the overlay system. The second stimulus is indicative of an operation to be executed on at least one of the master generic node and the one or more slave generic nodes in the first primary complex node. The processing circuitry is further configured to identify, based on the generic role associated with at least one of the master generic node and the one or more slave generic nodes, the first primary complex node in the executable graph-based model. The processing circuitry is further configured to communicate the second stimulus to the identified primary complex node. The processing circuitry is further configured to execute, the operation associated with the second stimulus using the identified primary complex node.

In some embodiments, to execute the first set of operations when each node of the first set of nodes is a secondary complex node, the processing circuitry is further configured to identify, from the first set of nodes, a set of secondary complex nodes that is associated with a second set of nodes of the plurality of nodes. The second set of nodes is different from the first set of nodes, and each secondary complex node of the set of secondary complex nodes has a secondary complex role that defines an association with at least one of the second set of nodes. The processing circuitry is further configured to determine, based on the first stimulus, a master secondary complex node and one or more slave secondary complex nodes from the set of secondary complex nodes. The processing circuitry is further configured to execute, based on the complex node behavior, a merge operation on the first set of nodes. During the execution, the one or more slave secondary complex nodes are merged into the master secondary complex node. The processing circuitry is further configured to associate the secondary complex role of each slave secondary complex node with the master secondary complex node. The processing circuitry is further configured to instantiate the first primary complex node in the executable graph-based model such that the first primary complex node corresponds to a merged node, that is a result of the merge operation executed to merge each slave secondary complex node of the first set of nodes in the master secondary complex node. The master secondary complex node has the secondary complex role of each slave secondary complex node that is included in the set of secondary complex nodes.

In some embodiments, the processing circuitry is further configured to receive a second stimulus associated with the overlay system. The second stimulus is indicative of an operation to be executed on at least one of the master secondary complex node and the one or more slave secondary complex nodes, in the first primary complex node. The processing circuitry is further configured to identify, based on the secondary complex role associated with at least one of the master secondary complex node and the one or more slave secondary complex nodes, the first primary complex node in the executable graph-based model. The processing circuitry is further configured to communicate the second stimulus to the identified primary complex node. The processing circuitry is further configured to execute, the operation associated with the second stimulus using the identified primary complex node.

In some embodiments, the processing circuitry is further configured to execute a second set of operations on the first primary complex node to rollback the first set of operations. The rollback of the first set of operations results in decomposition of the first primary complex node. The second set of operations includes a split operation when the complex node behavior is a join complex node behavior. The second set of operations includes an unmerge operation when the complex node behavior is a merge complex node behavior.

In some embodiments, the processing circuitry is further configured to (i) instantiate a complex usage overlay node for the first primary complex node and (ii) link the complex usage overlay node to the first primary complex node such that the complex usage overlay node is an overlay of the first primary complex node. The complex usage overlay node is configured to store and implement a set of constraints associated with the first primary complex node. The set of constraints includes one or more limitations associated with the first primary complex node that are to be adhered to while processing a second stimulus that is directed to the first primary complex node. The complex usage overlay node is further configured to maintain a log of operations performed on the first primary complex node for processing the second stimulus.

In some embodiments, one or more nodes of the first set of nodes are executable nodes. Each executable node of the first set of nodes is associated with a corresponding overlay node. The first set of operations is further executed on the overlay node associated with each executable node of the first set of nodes. The first primary complex node is created further based on the overlay node associated with each executable node of the first set of nodes.

In some embodiments, the overlay system further includes a context container that includes a set of defined contexts. The set of defined contexts includes (i) a complex node creation context indicative of the first set of operations for creation of the first primary complex node, (ii) a complex node modification context indicative of a second set of operations for modification of the first primary complex node, (iii) a complex node deletion context indicative of a third set of operations for deletion of the first primary complex node, and (iv) a rollback context indicative of a rollback operation for decomposition of the first primary complex node.

In some embodiments, the first set of operations for stimulus processing of the first stimulus is executed when a context of the first stimulus matches the node creation context in the set of defined contexts.

In some embodiments, the processing circuitry is further configured to load the first primary complex node with corresponding data and processing logic, where the first primary complex node is loaded based on a second stimulus that is associated with an operation to be executed on at least one of the set of nodes.

In some embodiments, the loading of the first primary complex node includes loading of each node of the first set of nodes with corresponding data and processing logic.

In some embodiments, each node of the first set of nodes is a run-time node that includes a node template and a node instance. The node template corresponds to a predefined node structure. The node instance corresponds to an implementation of the node template. The complex node behavior of the first set of nodes corresponds to a join complex node behavior based on one of from a group of (i) at least one run-time node of the first set of nodes having a node template that is different from node templates of remaining run-time nodes of the first set of nodes and (ii) each of the first set of nodes having an identical node template.

In some embodiments, based on at least one run-time node of the first set of nodes having the node template that is different from the node templates of the remaining run-time nodes of the first set of nodes, for execution of the first set of operations, the processing circuitry is configured to execute a first join operation on the node template of each run-time node of the first set of nodes to create a complex node template. The processing circuitry is further configured to execute a second join operation on the node instance of each run-time node of the first set of nodes to create a complex node instance. The complex node template includes a joined node template that has the node template of each run-time node and the complex node instance includes a joined node instance that has the node instance of each run-time node. The complex node template and the complex node instance, collectively, form the first primary complex node that is a run-time complex node.

In some embodiments, based on each of the first set of nodes having an identical node template, for execution of the first set of operations, the processing circuitry is configured to determine the identical node template to be a complex node template. The processing circuitry is further configured to execute a join operation on the node instance of each run-time node of the first set of nodes to create a complex node instance. The complex node instance includes a joined node instance that has the node instance of each run-time node. The complex node template and the complex node instance, collectively, form the first primary complex node that is a run-time complex node.

In some embodiments, each node of the first set of nodes is a run-time node that includes a node template and a node instance. The node template corresponds to a predefined node structure, whereas the node instance corresponds to an implementation of the node template. The complex node behavior of the first set of nodes corresponds to a merge complex node behavior when each run-time node of the first set of nodes has an identical node template. When the complex node behavior is the merge complex node behavior, for execution of the first set of operations the processing circuitry is configured to identify a master node instance and one or more slave node instances from the node instance of each node of the first set of nodes. The processing circuitry is further configured to execute a merge operation to merge the one or more slave node instances to the master node instance. When the complex node behavior is the merge complex node behavior, the first primary complex node includes a complex node template including the node template that is common to each run-time node and a complex node instance including a merged node instance that includes the node instance of each run-time node of the first set of nodes.

In some embodiments, each node of the first set of nodes is a run-time node that includes a node template and a node instance. The node template corresponds to a predefined node structure, whereas the node instance corresponds to an implementation of the node template. The first primary complex node includes a complex node template and a complex node instance. The complex node template corresponds to a combination of the node templates of the first set of nodes and the complex node instance corresponds to a combination of node instances of the first set of nodes.

In some embodiments, the processing circuitry is further configured to receive, a second stimulus that is indicative of an operation to be performed on the first primary complex node. The processing circuitry is further configured to identify one or more run-time nodes of the first set of nodes in the first primary complex node that are required for execution of the operation associated with the second stimulus. The processing circuitry is further configured to load, based on the second stimulus, the one or more run-time nodes with corresponding data and processing logic. For loading each run-time node of the one or more run-time nodes, corresponding node template and corresponding node instance are loaded with respective data and processing logic. The loading of the one or more run-time nodes results in loading of the first primary complex node.

In some embodiments, the processing circuitry is further configured to receive a second stimulus associated with the overlay system. The second stimulus is indicative of creation of a second primary complex node in the executable graph-based model. The processing circuitry is further configured to identify, from the plurality of nodes, based on the second stimulus, a third set of nodes associated with the creation of the second primary complex node. The third set of nodes includes at least one node that is included in the first set of nodes. The processing circuitry is further configured to determine, for each node of the third set of nodes, a node-type that indicates a node behavior of the corresponding node in the executable graph-based model. The processing circuitry is further configured to determine, based on the node-type of each node of the third set of nodes, a complex node behavior that is indicative of a second set of operations to be performed for the creation of the second primary complex node. The processing circuitry is further configured to execute the second set of operations on the third set of nodes to create the second primary complex node such that at least one node is common in the first and second primary complex nodes.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for facilitating creation and maintenance of complex nodes in the executable graph-based model. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

What is claimed is:

1. An overlay system, comprising:
a storage element configured to store an executable graph-based model that comprises a plurality of nodes; and
processing circuitry that is coupled to the storage element, and configured to:
receive a first stimulus associated with the overlay system, wherein the first stimulus is indicative of creation of a primary complex node in the executable graph-based model;
identify, from the plurality of nodes, based on the first stimulus, a first set of nodes associated with the creation of the primary complex node;
determine, for each node of the first set of nodes, a node-type that indicates a node behavior of the corresponding node in the executable graph-based model;
determine, based on the node-type of each node of the first set of nodes, a complex node behavior that is indicative of a first set of operations to be performed for the creation of the primary complex node; and
execute the first set of operations on the first set of nodes to create the primary complex node.

2. The overlay system of claim 1,
wherein the node behavior, of each node of the first set of nodes, corresponds to one of a group consisting of a vertex node behavior, an edge node behavior, and an overlay node behavior,
wherein each node with the vertex node behavior is configured to store data associated with the overlay system,
wherein each node with the edge node behavior is configured to couple two or more nodes, of the plurality of nodes, with the vertex node behavior, and
wherein each node with the overlay node behavior is configured to execute a processing logic on an associated node.

3. The overlay system of claim 1,
wherein the complex node behavior is one of a group consisting of a join complex node behavior and a merge complex node behavior,
wherein the join complex node behavior is indicative of the first set of operations including a join operation that is executed on the first set of nodes based on one of a group consisting of: (i) one or more nodes of the first set of nodes having a node-type that is different from node-types of remaining nodes of the first set of nodes and (ii) each node of the first set of nodes having an identical node-type, and
wherein the merge complex node behavior is indicative of the first set of operations including a merge operation that is executed on the first set of nodes based on each node of the first set of nodes having the identical node-type.

4. The overlay system of claim 1,
wherein the node-type of each node of the plurality of nodes is one of a group consisting of an edge node-type, a vertex node-type, and an overlay node-type,
wherein the primary complex node is a complex edge node based on the node-type of at least one node of the first set of nodes being the edge node-type,
wherein the primary complex node is a complex vertex node based on the node-type of each node of the first set of nodes being the vertex node-type, and
wherein the primary complex node is a complex overlay node based on the node-type of each node of the first set of nodes being an overlay node-type.

5. The overlay system of claim 1, wherein to execute the first set of operations, the processing circuitry is further configured to:
execute, based on the complex node behavior, a join operation on the first set of nodes;
identify, from the first set of nodes, a set of generic nodes that is associated with a second set of nodes of the plurality of nodes, wherein the second set of nodes is different from the first set of nodes, and wherein each node of the set of generic nodes has a generic role that defines an association with at least one of the second set of nodes;
create, for each generic node of the set of generic nodes, a primary complex role that defines an association between the primary complex node and one of the second set of nodes that is associated with the corresponding generic node of the set of generic nodes, where the primary complex role is mapped to the corresponding generic node of the set of generic nodes by way of the generic role; and
instantiate the primary complex node in the executable graph-based model such that the primary complex node corresponds to a joined node, that is a result of the join operation executed on the first set of nodes, having the primary complex role created for each node of the set of generic nodes.

6. The overlay system of claim 5, wherein the processing circuitry is further configured to:
receive a second stimulus associated with the overlay system, wherein the second stimulus is indicative of an operation to be executed using one or more generic nodes of the set of generic nodes in the primary complex node;
identify, based on the second stimulus, the primary complex node in the executable graph-based model;
determine one or more primary complex roles, associated with the primary complex node, that conform with the second stimulus;
map each of the one or more primary complex roles to a corresponding generic role;
identify, based on the mapping between each of the one or more primary complex roles and the corresponding generic role, the one or more generic nodes from the set of generic nodes in the primary complex node using which the operation is to be executed;
redirect the second stimulus to the one or more generic nodes of the set of generic nodes; and
execute the operation associated with the second stimulus using the one or more generic nodes.

7. The overlay system of claim 1, wherein to execute the first set of operations, based on each node of the first set of nodes being a secondary complex node, the processing circuitry is further configured to:
execute, based on the complex node behavior, a join operation on the first set of nodes;
identify, from the first set of nodes, a set of secondary complex nodes that is associated with a second set of nodes of the plurality of nodes, wherein the second set of nodes is different from the first set of nodes, and wherein each secondary complex node of the set of secondary complex nodes has a secondary complex role that defines an association with at least one of the second set of nodes;
create, for each of the set of secondary complex nodes, a primary complex role that defines an association between the primary complex node and one of the second set of nodes that is associated with the corresponding secondary complex node of the set of secondary complex nodes, where the primary complex role is mapped to the corresponding secondary complex node of the set of secondary complex nodes by way of the associated secondary complex role; and
instantiate the primary complex node in the executable graph-based model such that the primary complex node corresponds to a joined node, that is a result of the join operation executed on the first set of nodes, having the primary complex role created for each secondary complex node of the set of secondary complex nodes.

8. The overlay system of claim 7, wherein the processing circuitry is further configured to:
receive a second stimulus associated with the overlay system, wherein the second stimulus is indicative of an operation to be executed using the primary complex node;
determine one or more primary complex roles associated with the primary complex node that conform with the second stimulus;
map each of the one or more primary complex roles to a corresponding secondary complex role;
identify, based on the mapping between each of the one or more primary complex roles and the corresponding secondary complex role, one or more secondary complex nodes from the set of secondary complex nodes using which the operation is to be executed;
redirect the second stimulus to the identified one or more secondary complex nodes, wherein each identified secondary complex node has at least one secondary complex role;
map the secondary complex role of each identified secondary complex node to a corresponding generic role associated with a set of generic nodes included in the corresponding secondary complex node;
identify, based on the mapping between the secondary complex role of each identified secondary complex node and the corresponding generic role, the set of generic nodes on which the operation is to be executed; and
execute the operation associated with the second stimulus using the set of generic nodes of each identified secondary complex node.

9. The overlay system of claim 1, wherein to execute the first set of operations, the processing circuitry is further configured to:
identify, from the first set of nodes, a set of generic nodes that is associated with a second set of nodes of the plurality of nodes, wherein the second set of nodes is different from the first set of nodes, and each node of the set of generic nodes has a generic role that defines an association with at least one of the second set of nodes;
determine, based on the first stimulus, a master generic node and one or more slave generic nodes from the first set of nodes;
execute, based on the complex node behavior, a merge operation on the first set of nodes, where during the execution, the one or more slave generic nodes are merged into the master generic node;
associate the generic role, of the one or more slave generic nodes, with the master generic node; and
instantiate the primary complex node in the executable graph-based model such that the primary complex node corresponds to a merged node, that is a result of the merge operation executed to merge each slave generic node of the first set of nodes in the master generic node, where the master generic node has the generic role of each slave generic node of the set of generic nodes.

10. The overlay system of claim 9, wherein the processing circuitry is further configured to:
receive a second stimulus associated with the overlay system, wherein the second stimulus is indicative of an operation to be executed on at least one of the master generic node and the one or more slave generic nodes in the primary complex node;
identify, based on the generic role associated with at least one of the master generic node and the one or more slave generic nodes, the primary complex node in the executable graph-based model;
communicate the second stimulus to the identified primary complex node; and
execute, the operation associated with the second stimulus using the identified primary complex node.

11. The overlay system of claim 1, wherein to execute the first set of operations based on each node of the first set of nodes being a secondary complex node, the processing circuitry is further configured to:
identify, from the first set of nodes, a set of secondary complex nodes that is associated with a second set of nodes of the plurality of nodes, wherein the second set of nodes is different from the first set of nodes, and each secondary complex node of the set of secondary complex nodes has a secondary complex role that defines an association with at least one of the second set of nodes;
determine, based on the first stimulus, a master secondary complex node and one or more slave secondary complex nodes from the set of secondary complex nodes;
execute, based on the complex node behavior, a merge operation on the first set of nodes, where during the execution, the one or more slave secondary complex nodes are merged into the master secondary complex node;
associate the secondary complex role of each slave secondary complex node with the master secondary complex node; and
instantiate the primary complex node in the executable graph-based model such that the primary complex node corresponds to a merged node, that is a result of the merge operation executed to merge each slave secondary complex node of the first set of nodes in the master secondary complex node, where the master secondary complex node has the secondary complex role of each slave secondary complex node that is included in the set of secondary complex nodes.

12. The overlay system of claim 11, wherein the processing circuitry is further configured to:
receive a second stimulus associated with the overlay system, wherein the second stimulus is indicative of an operation to be executed on at least one of the master secondary complex node and the one or more slave secondary complex nodes, in the primary complex node;
identify, based on the secondary complex role associated with at least one of the master secondary complex node and the one or more slave secondary complex nodes, the primary complex node in the executable graph-based model;
communicate the second stimulus to the identified primary complex node; and
execute, the operation associated with the second stimulus using the identified primary complex node.

13. The overlay system of claim 1,
wherein the processing circuitry is further configured to execute a second set of operations on the primary complex node to rollback the first set of operations, where the rollback of the first set of operations results in decomposition of the primary complex node,
wherein the second set of operations includes a split operation based on the complex node behavior being a join complex node behavior, and
wherein the second set of operations includes an unmerge operation based on the complex node behavior being a merge complex node behavior.

14. The overlay system of claim 1,
wherein the processing circuitry is further configured to:
(i) instantiate a complex usage overlay node for the primary complex node; and
(ii) link the complex usage overlay node to the primary complex node such that the complex usage overlay node is an overlay node of the primary complex node; and
wherein the complex usage overlay node is configured to:
(i) store and implement a set of constraints associated with the primary complex node, where the set of constraints includes one or more limitations associated with the primary complex node that are to be adhered to while processing a second stimulus that is directed to the primary complex node; and
(ii) maintain a log of operations performed on the primary complex node for processing the second stimulus.

15. The overlay system of claim 1, further comprising a context container that includes a set of defined contexts,
wherein the set of defined contexts includes (i) a complex node creation context indicative of the first set of operations for creation of the primary complex node, (ii) a complex node modification context indicative of a second set of operations for modification of the primary complex node, (iii) a complex node deletion context indicative of a third set of operations for deletion of the primary complex node, and (iv) a rollback context indicative of a rollback operation for decomposition of the primary complex node, and
wherein the first set of operations for stimulus processing of the first stimulus is executed based on a context of the first stimulus being a match to the complex node creation context in the set of defined contexts.

16. The overlay system of claim 1,
wherein each node of the first set of nodes is a run-time node that includes a node template and a node instance, where the node template corresponds to a predefined node structure, whereas the node instance corresponds to an implementation of the node template, and
wherein the complex node behavior of the first set of nodes corresponds to a join complex node behavior based on one of from a group of (i) at least one run-time node of the first set of nodes having a node template that is different from node templates of remaining run-time nodes of the first set of nodes and (ii) each of the first set of nodes having an identical node template.

17. The overlay system of claim 16,
wherein based on at least one run-time node of the first set of nodes having the node template that is different from the node templates of the remaining run-time nodes of the first set of nodes, for execution of the first set of operations, the processing circuitry is configured to execute a first join operation on the node template of each run-time node of the first set of nodes to create a complex node template and execute a second join operation on the node instance of each run-time node of the first set of nodes to create a complex node instance,
wherein the complex node template corresponds to a joined node template that includes the node template of each run-time node and the complex node instance corresponds to a joined node instance that includes the node instance of each run-time node, and
wherein the complex node template and the complex node instance, collectively, form the primary complex node that corresponds to a run-time complex node.

18. The overlay system of claim 16,
wherein based on each of the first set of nodes having an identical node template, for execution of the first set of operations, the processing circuitry is configured to determine the identical node template to be a complex node template, and execute a join operation on the node instance of each run-time node of the first set of nodes to create a complex node instance,
wherein the complex node instance corresponds to a joined node instance that includes the node instance of each run-time node, and
wherein the complex node template and the complex node instance, collectively, form the primary complex node that corresponds to a run-time complex node.

19. A method, comprising:
receiving, by processing circuitry of an overlay system, a stimulus associated with the overlay system, an executable graph-based model, stored in a storage element of the overlay system, comprises a plurality of nodes, and wherein the stimulus is indicative of creation of a primary complex node in the executable graph-based model;
identifying, by the processing circuitry, from the plurality of nodes, based on the stimulus, a set of nodes associated with the creation of the primary complex node;
determining, by the processing circuitry, for each node of the set of nodes, a node-type that indicates a node behavior of the corresponding node in the executable graph-based model;
determining, by the processing circuitry, based on the node-type of each node of the set of nodes, a complex node behavior that is indicative of a set of operations to be performed for the creation of the primary complex node; and
executing, by the processing circuitry, the set of operations on the set of nodes to create the primary complex node.

20. A non-transitory computer-readable medium storing computer-executable instructions, the stored computer-executable instructions, when executed by a processing circuitry, cause the processing circuitry to perform operations comprising:
receiving a stimulus associated with an overlay system, an executable graph-based model, stored in a storage element of the overlay system, comprises a plurality of nodes, and wherein the stimulus is indicative of creation of a primary complex node in the executable graph-based model;
identifying, from the plurality of nodes, based on the stimulus, a set of nodes associated with the creation of the primary complex node; and
determining, for each node of the set of nodes, a node-type that indicates a node behavior of the corresponding node in the executable graph-based model;
determining, based on the node-type of each node of the set of nodes, a complex node behavior that is indicative of a set of operations to be performed for the creation of the primary complex node; and
executing the set of operations on the set of nodes to create the primary complex node.
